(19) United States
(12) Patent Application Publication
(10) Pub. No.: US 2022/0195257 A1
(43) Pub. Date: Jun. 23, 2022

(54) PRESSURE-SENSITIVE ADHESIVE TAPE AND METHOD FOR MOLDING PLASTIC LENS

(71) Applicant: Maxell Holdings, Ltd., Kyoto (JP)

(72) Inventors: Hirofumi TOMITA, Otokuni-gun, Kyoto (JP); Masanao SHIBUYA, Otokuni-gun, Kyoto (JP)

(21) Appl. No.: 17/434,965

(22) PCT Filed: Jan. 28, 2020
(86) PCT No.: PCT/JP2020/003009

§ 371 Date: Aug. 30, 2021

(30) Foreign Application Priority Data
Mar. 28, 2019 (JP) 2019-064565

(51) Int. Cl. C09J 7/38; C09J 7/29; C08G 18/38; C08G 18/76; B29D 11/00; G02B 1/04

(52) U.S. Cl. CPC C09J 7/385; C09J 7/29; C08G 18/3876; C08G 18/7642; B29K 2075/00; G02B 1/041; C09J 2433/00; C09J 2400/10; C09J 2467/006; B29D 11/0048

(57) ABSTRACT

A pressure-sensitive adhesive tape for molding a plastic lens having a substrate and a pressure-sensitive adhesive layer formed on a surface of the substrate. The pressure-sensitive adhesive layer includes an acrylic copolymer having a functional group and a crosslinking agent capable of reacting with the functional group; the acrylic copolymer has a weight-average molecular weight (M_{w}) of 1,100,000 or more and a molecular-weight polydispersity (M_{w}/Mₙ) of 10.0 or less; the pressure-sensitive adhesive layer has an elution percentage of 48.0% or less when immersed for two hours in toluene the temperature of which being adjusted to 80° C.; the pressure-sensitive adhesive tape exhibits a shift length of 0.15 mm or more and 0.50 mm or less after 800 minutes in a creep test; and the plastic lens has a refractive index of 1.59 or more.

### TECHNICAL FIELD

The present invention relates to a pressure-sensitive adhesive tape for molding a plastic lens, and more particularly to a pressure-sensitive adhesive tape for molding a high refractive plastic lens.

### BACKGROUND ART

Thermosetting optical resins for molding a plastic lens and their monomers, which have been put into practical use for spectacle lens applications, are classified into a polycondensation type typified by a thiourethane-based resin and a radical type typified by acrylic and vinyl compounds. Among them, the thiourethane-based resin has been widely used as an optical resin mainly for high-refractive index spectacle lens applications utilizing advantages such as having a high refractive index (for example, refractive index of 1.59 or more) because it contains a sulfur atom, and having excellent impact resistance because it forms a thiourethane bond.

The above-mentioned thiourethane-based resin can be obtained by forming a thiourethane bond by a condensation reaction between a polythiol component and a polyisocyanate component, and curing the resin, but in order to carry out polymerization while maintaining optical uniformity, it is necessary to carry out polymerization and curing while gradually raising the temperature from room temperature to a high temperature over a long period of time. For example, in the case of polymerization molding of a high refractive index spectacle lens, a long-time temperature elevation and curing process is required, which usually takes 24 hours or more to polymerize and cure it while gradually increasing the temperature from a normal temperature of about 20 to 30° C. to a high temperature of about 120 to 130° C. Therefore, the thiourethane-based resin is excellent in terms of performance as resin for molding a high refractive index plastic lens, but there is still room for improvement in terms of productivity.

In response to the above problem on productivity, for the purpose of providing a spectacle lens which is optically and physically excellent, as well as excellent in productivity, Patent Document 1 discloses that a resin obtained by polymerizing and curing a composition comprising a component obtained by prepolymerizing a polythiol compound having a specific structure with a polyisocyanate compound, a component comprising a (meth)acrylate compound having a specific structure, and a component comprising a compound copolymerizable with them is suitable for high refractive index lenses, and that short-time curing by heating is applicable for curing the composition. Regarding the short-time curing, in Examples, the following are disclosed. The composition was injected into a concave lens mold, cured by increasing the temperature from 50° C. to 130° C. over 3 hours, thereafter heat-cured at 130° C. for 1 hour, cooled to room temperature, and then released from the glass mold to obtain a colorless and transparent concave lens. It is seen that, compared with the above-described conventional temperature elevation curing process, the curing start temperature is higher, and the temperature elevation time is also shorter.

Also, although reducing optical defects is a main purpose, Patent Document 2 discloses, as a process for preparing a molded optical article, a batch process comprising:
introducing a component comprising (i) a dithiol or (ii) a polyisocyanate into a reaction vessel;
adding a first catalyst comprising an organotin halide to form a first reaction mixture;
heating the first reaction mixture;
introducing a second catalyst to the first reaction mixture;
mixing a polyisocyanate (ii) into the reaction vessel containing the first reaction mixture if a dithiol was first added, or mixing a dithiol (i) into the first reaction mixture if a polyisocyanate (ii) was first added, to form a second reaction mixture; and
filling a mold with the second reaction mixture to provide a filled mold to form a molded optical article. Regarding the batch process, in Examples, the following are disclosed. The second reaction mixture was filled into molds, the cure cycle began at 50° C. and ramped to 130° C. over 12 hours (0.11° C./rain). The samples were held at 130° C. for 6 hours before cooling to 70° C. over one hour and then cured lenses were obtained. It is seen that, compared with the above-described conventional temperature elevation curing process, the curing start temperature is higher, and the temperature elevation time is also shorter.

On the other hand, as a method for molding a plastic lens, a molding method by a cast polymerization method using a pair of glass molds (molds) and a sealing pressure-sensitive adhesive tape is known. In this method, a pair of glass molds are oppositely arranged at a predetermined interval. Next, the pressure-sensitive adhesive tape is stuck on the outer peripheral surfaces of the pair of glass molds along the circumferential direction over the entire periphery to prepare a polymerization cell. This seals a space between the glass molds with the pressure-sensitive adhesive tape. Next, a nozzle for resin injection is inserted through the pressure-sensitive adhesive tape to fill the space between the glass molds with a liquid resin (polymerizable monomers and polymerizable prepolymers). Then, the resin is polymerized and cured by heating, light irradiation, or the like to obtain a plastic lens. In order to obtain a high-quality plastic lens by this method, the pressure-sensitive adhesive tape for molding a plastic lens is required to have performance that does not cause appearance defects (whitening, wrinkles, and the like) on the outer peripheral edge of the plastic lens.

Patent Document 3 discloses an adhesive tape for manufacturing plastic lenses having a pressure-sensitive adhesive layer having a soluble fraction in toluene (20° C.) of 30% or less. In Examples, the following are disclosed. A diethylene glycol bisallyl carbonate-based lens raw material in liquid form is gradually heated from 40° C. to 110° C. over 35 hours to polymerize and cure the raw material, and then allowed to cool to room temperature to obtain a colorless and transparent lens without turbidity. However, when this adhesive tape for manufacturing plastic lenses is used for the above-mentioned brief temperature elevation process, namely for molding a high refractive index plastic lens by the process in which the curing start temperature is high and the temperature elevation time is also short, a colorless and transparent lens is not necessarily obtained. In the pressure-sensitive adhesive layer, the elution amount in the lens raw material from the adhesive layer increases under high temperature conditions, and whitening sometimes occurred on the outer peripheral edge of the obtained molded product. Further, when a highly-crosslinked structure is formed, the holding force of the pressure-sensitive adhesive becomes larger than necessary, and it becomes difficult to mitigate the influence of curing shrinkage of a raw material such as a thiourethane resin for high-refractive-index plastic lenses, that is, wrinkles are likely to occur on the pressure-sensitive adhesive tape, sometimes resulting in the occurrence of wrinkles on the side surface of the plastic lens. Therefore, there was room for improvement in the simultaneous suppression of whitening and wrinkles.

In general, the whitening of the plastic lens refers to a state in which the plastic lens looks white and turbid when the plastic lens is observed while irradiating it with light.

### RELATED DOCUMENTS

### Patent Documents

### Patent Document 1: JP H10-114825 A

### Patent Document 2: JP 2018-525499 A

### Patent Document 3: JP H5-255650 A

### SUMMARY OF INVENTION

### Problem to be Solved by Invention

The present invention has been made in view of the above problems, and it is an object of the present invention to provide a pressure-sensitive adhesive tape for molding a plastic lens, which can suppress the occurrence of defects such as wrinkles and whitening on the outer peripheral edge of a molded product, as well as a pressure-sensitive adhesive residue on an adherend when the pressure-sensitive adhesive tape is peeled off in molding a high refractive index plastic lens by a brief temperature elevation process, and a method for molding a plastic lens.

### Means for Solving Problem

For this purpose, the present inventors intensively studied the pressure-sensitive adhesive layer of the high-refractive-index pressure-sensitive adhesive tape for molding a plastic lens, and as a result, found that in molding a high refractive index plastic lens by a brief temperature elevation process, in order to suppress the occurrence of defects such as wrinkles and whitening on the outer peripheral edge of the molded product, first, it is important to make the weight-average molecular weight (M_{w}) and molecular-weight polydispersity (M_{w}/Mₙ) of a polymer (acrylic copolymer) used for the pressure-sensitive adhesive, and then if an acrylic pressure-sensitive adhesive designed so that the elution percentage when immersed for 2 hours in toluene the temperature of which being adjusted to 80° C. is 48.0% or less, and that the shift length in a creep test (temperature 40° C., load 0.5 kg) is 0.15 mm or more and 0.50 mm or less is used as the pressure-sensitive adhesive layer, the occurrence of whitening, wrinkles, bubbles, and pressure-sensitive adhesive residues on the plastic lens and side surfaces of the molds when peeling off the pressure-sensitive adhesive tape can be suppressed, thus completing the present invention.

That is, when a brief temperature elevation curing process with a higher curing start temperature and a shorter temperature elevation time compared with the conventional temperature elevation curing process, is adopted when molding a high refractive index plastic lens, in the pressure-sensitive adhesive tape used as a sealing tape, its pressure-sensitive adhesive layer is suddenly exposed to liquid to viscous and high-temperature polymerizable monomers and polymerizable prepolymers for plastic lenses which have not been sufficiently cured in the initial polymerization stage for about several hours. In particular, since the reaction between a polythiol and a polyisocyanate is slower than those of other monomers, their liquid to viscous state is long. Therefore, it is considered as follows: there is an increased risk of elution of part of a pressure-sensitive adhesive composition from the pressure-sensitive adhesive layer, such as monomers and prepolymers, in plastic lens materials, compared with the conventional temperature elevation curing process in which the temperature is gradually elevated from normal temperature to high temperature over a long period of time, and when the elution amount exceeds a certain amount, whitening is likely to occur on the outer peripheral edge of the obtained plastic lens molded product. However, if this problem is attempted to be solved only by the highly-crosslinked structure of the pressure-sensitive adhesive layer, whitening is suppressed, whereas as described above, the pressure-sensitive adhesive layer becomes harder than necessary, and it becomes difficult to mitigate the influence of curing shrinkage of high-refractive-index plastic lens raw materials, wrinkles are likely to occur the side surface of the plastic lens.

Therefore, in order to simultaneously dissolve both the occurrence of whitening and the occurrence of wrinkles, which are in the trade-off relationship described above in the molding of high-refractive-index plastic lenses, the present inventors first focused on the weight-average molecular weight (M_{w}) and molecular weight polydispersity (M_{w}/Mₙ) of the acrylic copolymer used for the pressure-sensitive adhesive layer, and studied. As a result, the inventors found as follows. If the weight-average molecular weight (M_{w}) of the acrylic copolymer is increased to 1,100,000 or more, and the molecular-weight polydispersity (M_{w}/Mₙ) is made to be 10.0 or less, low molecular weight components of the acrylic copolymer, low molecular components of homopolymers produced without copolymerization, specifically low molecular weight components having a weight-average molecular weight of less than 10,000 are extremely reduced. Therefore, even if the highly-crosslinked structure of the pressure-sensitive adhesive layer is contrived needlessly, the elution amount from the pressure-sensitive adhesive layer in the lens material can be suppressed, and the risk of the occurrence of whitening can be significantly reduced. On the other hand, the inventors also found as follows. Since the highly-crosslinked structure is not contrived, the pressure-sensitive adhesive layer does not become harder than necessary, the occurrence of wrinkles can also be suppressed, and the molecular weight is large and molecular-weight polydispersity is relatively small, it has a large cohesive force together with moderate flexibility, and the pressure-sensitive adhesive residues can also be suppressed.

The present invention comprises the following configuration. That is, the pressure-sensitive adhesive tape for molding a plastic lens according to the present invention is a pressure-sensitive adhesive tape for molding a plastic lens having a substrate and a pressure-sensitive adhesive layer formed on a surface of the substrate, wherein
the pressure-sensitive adhesive layer comprises an acrylic copolymer having a functional group and a crosslinking agent capable of reacting with the functional group; the acrylic copolymer has a weight-average molecular weight (M_{w}) of 1,100,000 or more and a molecular-weight polydispersity (M_{w}/Mₙ) of 10.0 or less; the pressure-sensitive adhesive layer has an elution percentage of 48.0% or less when immersed for two hours in toluene the temperature of which being adjusted to 80° C.; the pressure-sensitive adhesive tape exhibits a shift length of 0.15 mm or more and 0.50 mm or less after 800 minutes in a creep test; and the plastic lens has a refractive index of 1.59 or more.

In the above embodiment, it is preferred that the acrylic copolymer has a carboxyl group as a functional group, and that the crosslinking agent is a polyisocyanate-based compound.

Also, it is preferred that the acrylic copolymer has an acid value of 5.0 to 75.0 mgKOH/g, and that the equivalent ratio (NCO/COOH) of the equivalent of the isocyanate group (NCO) of the polyisocyanate-based compound to the equivalent of the carboxyl group (COOH) of the acrylic copolymer is 0.20 to 0.80.

Additionally, monomers as raw materials of the acrylic copolymer preferably contain a (meth)acrylic acid alkyl ester having an alkyl group having a carbon number of 5 to 18.

Additionally, the pressure-sensitive adhesive layer preferably has an elution percentage of 38% or less when immersed for 2 hours in toluene the temperature of which being adjusted to 80° C.

Additionally, the pressure-sensitive adhesive tape preferably exhibits a shift length of 0.20 mm or more and 0.50 mm or less after 800 minutes in a creep test.

Additionally, the plastic lens is a thiourethane-based resin.

Additionally, the substrate is preferably a composite substrate in which a sheet-shaped first substrate, an inorganic thin film layer, an adhesive layer, and a sheet-shaped second substrate are sequentially laminated.

Additionally, the pressure-sensitive adhesive tape for molding a plastic lens preferably has a water vapor transmission rate according to JIS K 7129 of 1.5 g/(m²/24 h) or less.

A method for molding a plastic lens comprises:
a cavity forming step of oppositely arranging a pair of molds at a predetermined interval, sticking the pressure-sensitive adhesive tape for molding a plastic lens of the above invention on outer peripheral edges of both the molds, and sealing an opening of a space formed between both the molds to form a cavity into which a polymerizable raw material is filled;
a polymerizable raw material filling step of filling the cavity with a polymerizable raw material for plastic lenses having a refractive index of 1.59 or more; and
a polymerization step of polymerizing the polymerizable raw material.

Furthermore, polymerization conditions of the polymerization step preferably include a polymerization start temperature of 45° C. or higher and 65° C. or lower, a final polymerization temperature of 130° C. or higher and 150° C. or lower, and a temperature elevation rate of 0.10° C./min or higher and 0.45° C./min or lower until the final polymerization temperature is reached.

Furthermore, the plastic lens is preferably a thiourethane-based resin.

### Effect of Invention

According to the present invention, there can be provided a pressure-sensitive adhesive tape for molding a high-refractive-index plastic lens, which can suppress the occurrence of defects such as whitening and wrinkles on the outer peripheral edge of a molded product, and the pressure-sensitive adhesive residue on an adherent when peeling off the pressure-sensitive adhesive tape in molding a high refractive index plastic lens by a brief temperature elevation process, and a method for molding a plastic lens.

### BRIEF DESCRIPTION OF DRAWINGS

FIG. 1 is a cross-sectional view showing the structure of a pressure-sensitive adhesive tape that is an embodiment of the present invention; and

FIG. 2 is a perspective view showing an example of the structure of a glass mold used in a method for molding a plastic lens according to the present invention.

### DESCRIPTION OF EMBODIMENTS

### (Configuration of Substrate)

A pressure-sensitive adhesive tape of the present invention has a substrate and a pressure-sensitive adhesive layer formed on a surface of the substrate. The substrate is a member that supports the pressure-sensitive adhesive layer. The substrate refers to a film-shaped material having tensile strength, heat resistance and flexibility. The substrate may consist of a single layer, or may also be a composite material having a plurality of layers.

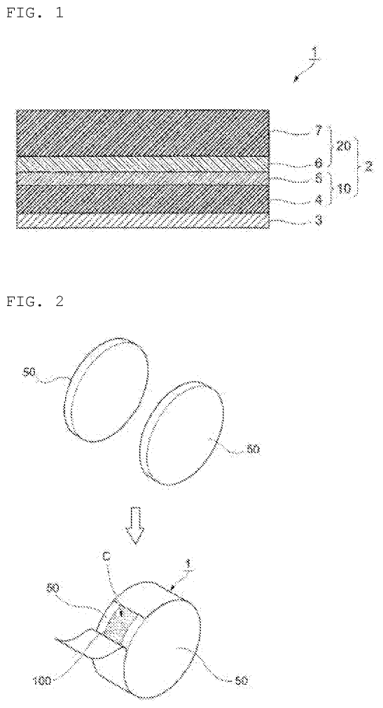

FIG. 1 is a cross-sectional view showing the structure of the pressure-sensitive adhesive tape that is an embodiment of the present invention. The pressure-sensitive adhesive tape 1 of the present embodiment is used for producing plastic lenses used for, for example, spectacle lenses. The pressure-sensitive adhesive tape 1 of the present embodiment preferably has a structure in which a composite substrate 2 and a pressure-sensitive adhesive layer 3 are laminated. Further, the composite substrate 2 preferably consists of a first laminated body 10 in which an inorganic thin film layer 5 is formed on a first substrate 4, and a second laminated body 20 in which an adhesive layer 6 is formed on a second substrate 7, with the laminated bodies being laminated together. Further, in the present embodiment, although the pressure-sensitive adhesive layer 3 is formed on a surface of the first substrate 4 side of the composite substrate 2, the pressure-sensitive adhesive layer 3 may also be formed on a surface of a third substrate 7 side of the composite substrate 2.

In the pressure-sensitive adhesive tape 1 of the present embodiment, if necessary, an anchor coat layer (not shown) for improving adhesion may be provided between the composite substrate 2 (first substrate 4) and the pressure-sensitive adhesive layer 3, or between the first substrate 4 and the inorganic thin film layer 5.

### <Composite Substrate>

As described above, in the composite substrate 2 of the present embodiment, the laminated body 10 and the second laminated body 20 are laminated, thereby having a structure in which the first substrate 4, the inorganic thin film layer 5, and the adhesive layer 6 are sequentially laminated.

Hereinafter, each layer constituting the composite substrate 2 will be described.

### [First Substrate]

The material of the first substrate 4 used for the pressure-sensitive adhesive tape 1 of the present embodiment is not particularly limited, and for example, a substrate made of plastic, metal, or the like may be used.

Among these, it is particularly preferable to use a substrate containing polyethylene terephthalate (PET) as a main component. Further, as the first substrate 4, for example, resin films such as polybutylene terephthalate, polyethylene naphthalate, polyphenylene sulfide, biaxially oriented polypropylene, polyimide, aramid, polycycloolefin, fluororesin and the like may be used.

The details will be described later, but the inorganic thin film layer 5 containing, for example, silicon, aluminum or the like is provided on the first substrate 4 of the present embodiment.

When polyethylene terephthalate (PET) is used as the first substrate 4, the thickness of the first substrate 4 is preferably in the range of 9 μm or more and 25 μm or less.

When the thickness of the first substrate 4 is less than 9 μm, unevenness in the film thickness of the first substrate 4 increases in the width direction of the pressure-sensitive adhesive tape 1, and when the inorganic thin film layer 5 is laminated on the first substrate 4, wrinkles, breaks, and the like are likely to occur. As a result, the water vapor transmission rate of the pressure-sensitive adhesive tape 1 may partially increase, and bubbles and whitening tend to occur easily in the plastic lens manufactured by using the pressure-sensitive adhesive tape 1.

Further, in the manufacturing process of the pressure-sensitive adhesive tape 1 described below, the first laminated body 10 in which the inorganic thin film layer 5 is laminated on the first substrate 4 is usually wound up so that the inorganic thin film layer 5 side is an outer periphery. Here, if the thickness of the first substrate 4 exceeds 25 μm, the outer periphery side (the inorganic thin film layer 5 side) of the first laminated body 10 is easily stretched when the first laminated body 10 is wound, compared with the case where the thickness of the first substrate 4 is 25 μm or less. As a result, due to stretching of the inorganic thin film layer 5 in the first laminated body 10, cracks may occur over the entire inorganic thin film layer 5. In the pressure-sensitive adhesive tape 1 in which the inorganic thin film layer 5 is cracked in this manner, the water vapor transmission rate may increase, and bubbles and whitening tend to easily occur in the plastic lens manufactured by using the pressure-sensitive adhesive tape 1.

### [Second Substrate]

The material of the second substrate 7 is not particularly limited as in the first substrate 4, and for example, a substrate made of plastic, metal, or the like may be used.

Among these, it is particularly preferable to use a substrate containing polyethylene terephthalate (PET) as a main component. Further, as the second substrate 7, similarly to the first substrate 4, for example, resin films such as polybutylene terephthalate, polyethylene naphthalate, polyphenylene sulfide, biaxially oriented polypropylene, polyimide, aramid, polycycloolefin, and fluororesin may be used.

When polyethylene terephthalate (PET) is used as the second substrate 7, the thickness of the second substrate 7 is preferably in the range of 18 μm or more and 38 μm or less.

If the thickness of the second substrate 7 is excessively small, the rigidity of the second substrate 7 tends to decrease, and it tends to become difficult to maintain the interval between the two molds 50 (see FIG. 2) in the plastic lens manufacturing process described below. Also, if the thickness of the second substrate 7 is excessively small, the pressure-sensitive adhesive tape 1 may be cracked or cut since it cannot withstand the expanding force of the resin for molding a plastic lens (meaning monomers and/or oligomers) injected into the cavity C formed by the molds 50 and the pressure-sensitive adhesive tape 1, which may result in entering of air into the cavity. Furthermore, if the thickness of the second substrate 7 is excessively small, the pressure-sensitive adhesive tape 1 is pulled toward the center in the cavity C as if being crushed, since the pressure-sensitive adhesive tape 1 cannot withstand the contraction force of the resin for molding a plastic lens 100 in the cavity C, and therefore there is a concern that wrinkles (tape wrinkles) attributable to the wrinkles of the pressure-sensitive adhesive tape 1 may occur on the lens to be formed.

On the other hand, when the thickness of the second substrate 7 is excessively large, the rigidity of the second substrate 7 easily increases, and the stretchability of the pressure-sensitive adhesive tape 1 tends to decrease. Also, the total thickness of the pressure-sensitive adhesive tape 1 becomes large, and when the pressure-sensitive adhesive tape 1 is wound around the molds 50 in the plastic lens manufacturing process described below, at a lap portion where the pressure-sensitive adhesive tape 1 overlaps itself, a gap occurs between overlapping portions of the pressure-sensitive adhesive tape, and the resin 100 may leak from the cavity C.

Considering the relationship between the first substrate 4 and the second substrate 7, the thickness of the second substrate 7 is preferably in the range of 2 times or more and 3 times or less the thickness of the first substrate 4. The first substrate 4 and the second substrate 7 having such a relationship makes it possible to suppress the load applied on the inorganic thin film layer 5 provided between the first substrate 4 and the second substrate 7 when the pressure-sensitive adhesive tape 1 is wound, or accompanying deformation of the pressure-sensitive adhesive tape 1 in the manufacturing process of a plastic lens. Furthermore, the first substrate 4 and the second substrate 7 having such a relationship can make the rigidity and stretchability of the entire pressure-sensitive adhesive tape 1 in preferred ranges for molding applications of plastic lenses. This makes it possible to suppress the mixing of moisture into the cavity C and the occurrence of leakage of resin 100 from the cavity C in the manufacturing process of the plastic lens described below.

Furthermore, the total combined thickness of the first substrate 4 and the second substrate 7 is preferably in the range of 27 μm or more and 60 μm or less. The total combined thickness of the first substrate 4 and the second substrate 7 in such a range makes it possible to suppress liquid leakage due to a difference in level in the lap portion where the pressure-sensitive adhesive tape 1 overlaps itself and to suppress breakage and peeling off of the pressure-sensitive adhesive tape 1 due to deformation accompanying shrinkage of the resin 100 or the like in the plastic lens manufacturing process described below.

### [Inorganic Thin Film Layer]

The inorganic thin film layer 5 is composed of an inorganic substance, and provided to enhance moisture barrier characteristics and gas barrier characteristics of the pressure-sensitive adhesive tape 1 and suppress permeation of moisture in the pressure-sensitive adhesive tape 1.

Examples of the inorganic substance constituting the inorganic thin film layer 5 include silicon, aluminum, magnesium, zinc, tin, nickel, titanium, hydrocarbons and the like, or their oxides, carbides, nitrides or mixtures thereof. Among them, it is preferable to use a substance mainly composed of silicon oxide, silicon nitride, aluminum oxide, aluminum nitride, and hydrocarbons such as diamond-like carbon. In particular, it is more preferable to use silicon dioxide or aluminum oxide as the inorganic thin film layer 5 in that the permeation of moisture in the pressure-sensitive adhesive tape 1 can be suppressed.

The above inorganic substances may be used alone or in combination of two or more.

As a method for forming the inorganic thin film layer 5, known methods such as a vapor deposition method and a coating method may be used. In particular, it is preferable to adopt a vapor deposition method in that a uniform thin film having high moisture barrier characteristics and gas barrier characteristics can be obtained. The vapor deposition method includes methods such as PVD (Physical Vapor Deposition Method) including vacuum vapor deposition, ion plating, and sputtering, and CVD (Chemical Vapor Deposition Method).

The thickness of the inorganic thin film layer 5 is, for example, in the range of 0.1 nm to 500 nm, and preferably in the range of 0.5 nm to 40 nm. Setting the thickness of the inorganic thin film layer 5 within the above range can suppress permeation of moisture, and can suppress the occurrence of cracks and the like in the inorganic thin film layer 5. Furthermore, setting the thickness of the inorganic thin film layer 5 within the above range can suppress a reduction in the transparency of the pressure-sensitive adhesive tape 1.

### [Adhesive Layer]

The adhesive layer 6 is provided to bond the inorganic thin film layer 5 in the laminated body 10 and the second substrate 7 in the second laminated body 20. The adhesive layer 6 is formed by an adhesive. As the adhesive forming the adhesive layer 6, for example, a polyester-based adhesive that is cured with an isocyanate-based curing agent may be used. However, the adhesive used for the adhesive layer 6 is not limited to them, and known materials such as epoxy-based adhesives and polyether-based adhesives may be used.

The thickness of the adhesive layer 6 is preferably in the range of 1 μm or more and 10 μm or less. If the thickness of the adhesive layer 6 is excessively small, the adhesive strength between the adhesive layer 6 and the inorganic thin film layer 5 tends to be insufficient. If the adhesive strength with the inorganic thin film layer 5 decreases, the inorganic thin film layer 5 is likely to be cracked and the water vapor transmission rate in the pressure-sensitive adhesive tape 1 easily increases. On the other hand, if the thickness of the adhesive layer 6 is excessively large, the total thickness of the pressure-sensitive adhesive tape 1 easily increases. If the total thickness of the pressure-sensitive adhesive tape 1 becomes thicker, when the pressure-sensitive adhesive tape 1 is wound around the molds 50 in the plastic lens manufacturing process described below, at the lap portion where the pressure-sensitive adhesive tape 1 overlaps itself, a gap occurs between the overlapping portions of the pressure-sensitive adhesive tape, and the resin 100 may leak from the cavity C.

### <Pressure-Sensitive Adhesive Layer>

The pressure-sensitive adhesive layer 3 of the present embodiment contains an acrylic copolymer as a base compound polymer of pressure-sensitive adhesive. Hereinafter, the acrylic copolymer will be described in detail.

### [Acrylic Copolymer]

The acrylic copolymer refers to a copolymer obtained by polymerizing a monomer mixture containing monomers having a (meth)acrylic group. The monomer mixture includes, for example, (meth)acrylic acid alkyl esters, ethylenically unsaturated monomers having functional groups, and the like.

The acrylic copolymer has a weight-average molecular weight (M_{w}) of 1,100,000 or more and a molecular-weight polydispersity (M_{w}/Mₙ) of 10.0 or less. For the weight-average molecular weight (M_{w}) and number average molecular weight (Mₙ) values, polystyrene equivalent values measured by gel permeation chromatography are used.

When the weight-average molecular weight (M_{w}) is less than 1,100,000, low molecular weight components having a molecular weight of less than 10,000 inevitably increase, and in the manufacturing process of a high refractive index plastic lens by the brief temperature elevation process, a risk that part of the pressure-sensitive adhesive layer 3 is eluted in the resin for molding a plastic lens increases, and whitening may possibly occur on the outer peripheral edge of the obtained plastic lens molded product. On the other hand, although the upper limit of the weight-average molecular weight (M_{w}) is not particularly limited, it is preferably 2,000,000 or less. If the weight-average molecular weight (M_{w}) exceeds 2,000,000, due to an increase in the viscosity of a pressure-sensitive adhesive composition solution, uniform coatability is possibly difficult to obtain. In addition, stress relaxation characteristics of the pressure-sensitive adhesive layer 3 deteriorate, and wrinkles may occur on the side surface of the obtained plastic lens molded product. The weight-average molecular weight (M_{w}) is preferably in the range of 1,200,000 or more and 1,500,000 or less.

When the molecular-weight polydispersity (M_{w}/Mₙ) of the above molecular weight exceeds 10.0, low molecular weight components having a molecular weight of less than 10,000 inevitably increase in the manufacturing process of a high refractive index plastic lens by the brief temperature elevation process, and the risk that part of the pressure-sensitive adhesive layer 3 is eluted in the resin for molding a plastic lens increases in the, and whitening may possibly occur on the outer peripheral edge of the obtained plastic lens molded product. On the other hand, the lower limit of the molecular-weight polydispersity (M_{w}/Mₙ) is not particularly limited, but is preferably 5.0 or more. When the molecular-weight polydispersity (M_{w}/Mₙ) is less than 5.0, stress relaxation characteristics of the pressure-sensitive adhesive layer 3 deteriorate when the weight-average molecular weight (M_{w}) is particularly large, and wrinkles may occur on the side surface of the obtained plastic lens molded product.

By setting the weight-average molecular weight (M_{w}) and molecular-weight polydispersity (M_{w}/Mₙ) of the acrylic copolymer in the above ranges, low molecular weight components of the acrylic copolymer that is the base compound polymer of the pressure-sensitive adhesive can be almost eliminated. Therefore, it is possible to significantly suppress the risk that part of the pressure-sensitive adhesive layer 3 is eluted in the resin for molding a plastic lens 100 in the manufacturing process of a high refractive index plastic lens by the brief temperature elevation process without contriving a highly-crosslinked structure needlessly. Furthermore, since the pressure-sensitive adhesive layer 3 does not become hard more than necessary and can maintain appropriate stress relaxation characteristics, the effect of cure shrinkage of a high refractive index plastic lens can also be mitigated. As a result, the occurrence of whitening on the peripheral edge and of wrinkles on the side surface of the plastic lens molded product is suppressed. In addition, since the cohesive force of the pressure-sensitive adhesive layer 3 is also high, the resin 100 does not leak from the lens cavity C and polymerization curing proceeds, thus making it possible to suppress the occurrence of bubbles and chips on the outer peripheral edge of the obtained plastic lens, as well as possible to suppress the occurrence of the pressure-sensitive adhesive residues on the molds 50 and on the side surface of the plastic lens molded product when the pressure-sensitive adhesive tape 1 is peeled off from the molds 50 after polymerization curing.

The above (meth)acrylic acid alkyl ester is not particularly limited, but from the viewpoint of reducing the solution viscosity of the acrylic copolymer increased in molecular weight, and from the viewpoint of optimizing the shift length in the creep test, the carbon number of the alkyl group is preferably in the range of 5 to 18, and more preferably in the range of 8 to 14. If the alkyl group has a large carbon number, a functional group of the acrylic copolymer, which will be described below, is moderately concealed by the alkyl group having a large carbon number and, it does not form an extremely highly-crosslinked structure, so that it becomes easy to have stress relaxation characteristics. As a result, the shift length in the creep test is easily made to be in an appropriate range. Examples of the (meth)acrylic acid alkyl ester include 2-ethylhexyl acrylate (the carbon number of the alkyl group [hereinafter, simply abbreviated as carbon number]: 8, homopolymer Tg [hereinafter, simply abbreviated as Tg]: −70° C.), isodecyl acrylate (carbon number: 10, Tg: −60° C.), isoundecyl acrylate (carbon number: 11), isododecyl acrylate (carbon number: 12), isotridecyl acrylate (carbon number 13), isomiristyl acrylate (carbon number: 14, Tg: −56° C.), decyl methacrylate (carbon number: 10, Tg: −74° C.), dodecyl acrylate (carbon number: 12, Tg: −8° C.), dodecyl methacrylate (carbon number: 12), Tg: −65° C.), tridecyl methacrylate (carbon number: 13, Tg: −40° C.), isodecyl methacrylate (carbon number: 10, Tg: −41° C.), undecyl methacrylate (carbon number: 11), tetradecyl methacrylate (carbon number: 14, Tg: −15° C.) and the like.

The ethylenically unsaturated monomer having a functional group is not particularly limited, but includes carboxyl group-containing monomers such as acrylic acid, methacrylic acid, maleic acid, and itaconic acid; hydroxyl group-containing monomers such as 2-hydroxyethyl (meth)acrylate, 2-hydroxypropyl (meth) acrylate; and epoxy group-containing monomers such as glycidyl (meth)acrylate and allyl glycidyl ether. From the viewpoint of imparting the moderate stress relaxation characteristics to the pressure-sensitive adhesive layer 3, the functional group of the ethylenically unsaturated monomer is preferably a carboxyl group.

Other monomers that may be included in the monomer mixture include acrylonitrile, methacrylonitrile, styrene, α-methyl styrene, vinyl acetate, vinyl propionate, vinyl chloride, alkyl vinyl ether, dimethylaminoethyl (meth)acrylate, 2-methoxyethyl (meth)acrylate, butoxyethyl (meth)acrylate, methoxytriethylene glycol (meth)acrylate and the like.

In the above acrylic polymer, the content ratio of the (meth)acrylic acid alkyl ester monomer, the ethylenically unsaturated monomer having a functional group, and the other monomers are preferably 60 to 99.3% by mass for the (meth)acrylic acid alkyl ester, 0.7 to 10% by mass for the ethylenically unsaturated monomer having a functional group, and 0 to 39.3% by mass for the other monomers, and more preferably 70 to 99% by mass for the (meth)acrylic acid alkyl ester, 1 to 5% by mass for the ethylenically unsaturated monomer having a functional group, and 0 to 29% by mass for the other monomers.

The functional group of the acrylic copolymer is a functional group that serves as a crosslinking point to be crosslinked by a crosslinking agent described below. The functional group is introduced as a side chain by copolymerizing an ethylenically unsaturated monomer having a functional group. Among these functional groups, a carboxyl group and a hydroxyl group having an active hydrogen are preferable from the viewpoint of reactivity and versatility. A carboxyl group is more preferable from the viewpoint of suppression of the occurrence of whitening and wrinkles of the obtained plastic lens simultaneously. When the functional group is a carboxyl group, the acid value of the acrylic copolymer is preferably in the range of 5.0 to 75.0 mgKOH/g, more preferably in the range of 7.0 to 38.0 mgKOH/g. When the functional group is a hydroxyl group, the hydroxyl value of the acrylic copolymer is preferably in the range of 3.0 to 48.0 mgKOH/g, more preferably in the range of 4.8 to 24.0 mgKOH/g.

When the amount of the functional group (acid value, hydroxyl value) of the acrylic copolymer is less than the lower limit of the above range, if the amount of the crosslinking agent added described below is small, the crosslinking of the pressure-sensitive adhesive layer 3 becomes insufficient. Therefore, in the manufacturing process of a high refractive index plastic lens by the brief temperature elevation process, the risk that part of the pressure-sensitive adhesive layer 3 is eluted in the resin for molding a plastic lens increases, and whitening may possibly occur on the outer peripheral edge of the obtained plastic lens molded product. The cohesive force of the pressure-sensitive adhesive layer 3 also becomes insufficient, and the pressure-sensitive adhesive residues may occur on the molds 50 and on the side surface of the plastic lens molded product when the pressure-sensitive adhesive tape 1 is peeled off from the molds 50 after polymerization curing. On the other hand, when the amount of the functional group (acid value, hydroxyl value) exceeds the upper limit of the above range, since the pressure-sensitive adhesive layer 3 forms a highly-crosslinked structure needlessly, and becomes too hard, the stress relaxation characteristics of the pressure-sensitive adhesive layer deteriorate. Therefore, wrinkles may possibly occur on the side surface of the obtained plastic lens molded product. In addition, if the amount of the crosslinking agent added, which will be described later, is large, the adhesive force of the pressure-sensitive adhesive layer 3 decreases, and the fixing force to the mold 50 may deteriorate.

The acrylic copolymer can be produced by a usual polymerization method. For example, it can be produced by applying a polymerization method such as solution polymerization, photopolymerization, bulk polymerization, suspension polymerization or emulsion polymerization to a monomer mixture containing predetermined amounts of required monomers depending on the intended monomer composition. In this process, if necessary, suitable polymerization initiators or molecular weight modifiers, chain transfer agents, and the like are used together. From the viewpoint of versatility and workability, it is preferably polymerized by solution polymerization.

In the case of solution polymerization, specifically, monomer components and, if necessary, a chain transfer agent, a polymerization solvent and the like are charged in a reaction container, and for example, a polymerization initiator is added in an inert gas atmosphere such as nitrogen gas. The reaction initiation temperature is usually set in the range of 40 to 100° C., and the temperature required for maintaining the reaction system is usually set in the range of 50 to 90° C., followed by the reaction for 2 to 20 hours. Further, a polymerization initiator, a chain transfer agent, a monomer component, and a polymerization solvent may be additionally added as appropriate during the polymerization reaction.

Among the above polymerization solvents, when polymerizing an acrylic copolymer, it is preferable to use an organic solvent that does not easily cause chain transfer during the polymerization reaction, for example, esters and ketones, and, particularly from the viewpoint of the solubility of the acrylic copolymer and the ease of polymerization reaction, it is preferable to use ethyl acetate, methyl ethyl ketone, acetone and the like.

As the polymerization initiator, organic peroxides, azo-based compounds and the like that are usable in ordinary solution polymerization may be used. Among these polymerization initiators, when the acrylic copolymer is polymerized, it is prefererable to use an azo-based compound that does not easily cause a hydrogen abstraction reaction as the polymerization initiator at the initial stage of the polymerization, and to use an organic peroxide with good initiator efficiency as the polymerization initiator at the late stage of the polymerization. In this manner, by changing the type of polymerization initiator added between the initial stage and the late stage of polymerization, an acrylic copolymer having a high weight-average molecular weight (M_{w}) and a moderate molecular-weight polydispersity (M_{w}/Mₙ) can be preferably synthesized.

### [Crosslinking Agent]

The pressure-sensitive adhesive layer 3 of the present embodiment contains a crosslinking agent having a functional group capable of reacting with a functional group of the ethylenically unsaturated monomer having the functional group for the purpose of crosslinking the acrylic polymer. Examples of the crosslinking agent include polyisocyanate-based compounds, melamine-based compounds, aziridine-based compounds, epoxy-based compounds, oxazoline-based compounds, carbodiimide-based compounds, metal-based compounds such as metal complexes, and amino group-containing compounds. Among these crosslinking agents, polyisocyanate-based compounds are preferable from the viewpoints of reactivity, impartment of heat resistance, and versatility.

Examples of the polyisocyanate-based compounds include isocyanate monomers such as tolylene diisocyanate, chlorophenylene diisocyanate, hexamethylene diisocyanate, tetramethylene diisocyanate, isophorone diisocyanate, xylylene diisocyanate, diphenylmethane diisocyanate, and hydrogenated diphenylmethane diisocyanate; isocyanate compounds and isocyanurates obtained by adding trimethylolpropane and the like to these isocyanate monomers, bullet-type compounds, and urethane prepolymer type isocyanate obtained by addition reaction of polyether polyols, polyester polyols, acrylic polyols, polybutadiene polyols, polyisoprene polyols, and the like. Further, commercially available isocyanate-based crosslinking agents, for example, Coronate L-45 (trade name) manufactured by Soken Chemical and Engineering Co., Ltd., Takenate A-56 (trade name) manufactured by Mitsui Chemicals, Inc. and the like may also be used. These isocyanate-based compounds may be used alone or in combination of two or more.

From the viewpoint of suppressing the occurrence of whitening and wrinkles on the obtained plastic lens simultaneously, as well as suppression of the pressure-sensitive adhesive residues, the content of the above-mentioned crosslinking agents may be adjusted as appropriate so that the pressure-sensitive adhesive layer has an elution percentage of 48.0% or less when immersed for two hours in toluene the temperature of which being adjusted to 80° C., and that the pressure-sensitive adhesive tape exhibits a shift length of 0.15 mm or more and 0.50 mm or less after 800 minutes in a creep test. Although it is not necessarily appropriate to suggest the content of the crosslinking agent because there is a balance with the amount of the functional group in the acrylic copolymer, for example, the content of the crosslinking agent is preferably adjusted to be in the range of 1.3 to 5.0 parts by mass with respect to 100 parts by mass of the acrylic copolymer. The equivalent ratio of the isocyanate group of the crosslinking agent to the active hydrogen-containing functional group of the acrylic copolymer, that is, the equivalent ratio of NCO (the isocyanate group of the crosslinking agent) to COOH (the carboxyl group of the acrylic copolymer) or NCO (the isocyanate group of the crosslinking agent) to OH (the hydroxyl group of the acrylic copolymer), i.e., NCO/COOH, NCO/OH, is preferably in the range of 0.20 to 0.80.

### [Thickness]

The thickness of the pressure-sensitive adhesive layer 3 is preferably in the range of 10 μm or more and 50 μm or less. If the thickness of the pressure-sensitive adhesive layer is layer 3 is less than 10 μm, the fixing force to the molds 50 and the adhesive force of the overlapping portions of the pressure-sensitive adhesive tape 1 decrease, and air bubbles and chips may possibly occur on the outer peripheral edge of the obtained plastic lens. On the other hand, if the thickness of the pressure-sensitive adhesive layer 3 is more than 50 μm, the thickness of the pressure-sensitive adhesive tape 1 becomes too thick, a gap occurs at the lap portion of the pressure-sensitive adhesive tape, so that the resin 100 may leak from the cavity C.

### [Pressure-Sensitive Adhesive Tape]

The pressure-sensitive adhesive layer has an elution percentage of 48.0% or less, preferably 38.0% or less, when immersed for two hours in toluene the temperature of which being adjusted to 80° C. When the elution percentage exceeds 48.0%, if a brief temperature elevation curing process in which the curing start temperature is high, and the temperature elevation time is short is adopted in the plastic lens manufacturing process described below, that is, when the pressure-sensitive adhesive layer is exposed to viscous and high temperature polymerizable monomers and polymerizable prepolymers that have not been sufficiently cured in the initial stage of polymerization for several hours or more, the risk that part of the pressure-sensitive adhesive composition is eluted from the pressure-sensitive adhesive layer 3 in the monomers and prepolymers that are raw materials for the plastic lenses molding resin rapidly increases compared with the conventional temperature elevation curing process of gradually elevating the temperature from normal temperature to high temperature over a long time, and whitening occurs on the outer peripheral edges of the obtained plastic lens molded products due to the influence of the eluted material. When the elution percentage is 48.0% or less, the influence of the eluted material can be suppressed to a level that does not cause a problem. Therefore, whitening at a level causing a problem in quality does not occur on the outer peripheral edge of the obtained plastic lens.

Further, the pressure-sensitive adhesive tape 1 of the present embodiment exhibits a shift length of 0.15 mm or more and 0.50 mm or less after 800 minutes in a creep test (temperature: 40° C., load: 0.5 kg). When the above shift length is within this range, a phenomenon of wrinkling on the outer peripheral edge of the plastic lens molded product can be suppressed even if the polymerizable monomers and/or the polymerizable prepolymers are cured and shrunk in the plastic lens manufacturing process described below. Further, the occurrence of the pressure-sensitive adhesive residues on the mold 50 and on the side surface of the plastic lens molded product when the pressure-sensitive adhesive tape 1 is peeled off from the molds 50 after polymerization curing is also suppressed. The shift length is preferably in the range of 0.20 mm to 0.50 mm.

### <Thickness of Pressure-Sensitive Adhesive Tape>

The overall thickness of the pressure-sensitive adhesive tape 1 having the structure as described above is preferably in the range of 37 μm or more and 110 μm or less. When the thickness of the pressure-sensitive adhesive tape 1 is less than 37 μm, the pressure-sensitive adhesive layer 3 becomes thin, so that the fixing force to the molds 50 and the adhesive force between the overlapping portions of the pressure-sensitive adhesive tape 1 decreases, and the resin 100 leaks from the lens cavity. Therefore, bubbles or chips may occur on the outer peripheral edge of the obtained plastic lens. On the other hand, if the thickness of the pressure-sensitive adhesive tape 1 exceeds 110 μm, the thickness of the pressure-sensitive adhesive tape 1 becomes too thick, and a gap is likely to occur in the lap portion of the pressure-sensitive adhesive tape, which may possibly cause the resin 100 to leak from the cavity C.

### (Manufacturing Method of Pressure-Sensitive Adhesive Tape)

Subsequently, giving as an example the pressure-sensitive adhesive tape 1 to which the first embodiment described in FIG. 1 is applied, the manufacturing method thereof will be described. A pressure-sensitive adhesive tape 1 is formed by forming a composite substrate 2 and laminating a pressure-sensitive adhesive layer 3 on the formed composite substrate 2.

### [Formation of Composite Substrate]

First, an adhesive made of, for example, a polyester-based urethane adhesive, an epoxy resin adhesive or the like is applied to a polyethylene terephthalate (PET) film used as a second substrate 7 with a gravure roll or the like and dried. Thereby, a laminated body 20 in which the adhesive layer 6 is laminated on the second substrate 7 is formed. Subsequently, to the thus formed second laminated body 20, a first laminated body 10 obtained by laminating an inorganic thin film layer 5 composed of silicon dioxide or the like on a polyethylene terephthalate (PET) film used as a first substrate 4 is laminated so that the inorganic thin film layer 5 and the adhesive layer 6 face each other. Thereby, a composite substrate 2 in which the first laminated body 10 and the second laminated body are laminated is formed. After that, the composite substrate 2 is wound so that the laminated body 10 side (the first substrate 4 side) is on the inside, and the wound composite substrate 2 is aged in an atmosphere at 40° C. to 50° C. for 48 hours.

Incidentally, in the step of forming the composite substrate 2, for example, when the adhesive layer 6 is formed by directly applying the adhesive to the inorganic thin film layer 5 laminated on the first substrate 4, and the second substrate 7 is laminated on the adhesive layer 6 to form the composite substrate 2, cracks, fissures and the like may occur in the inorganic thin film layer 5. Specifically, when the adhesive is applied to the inorganic thin film layer 5, or when the second substrate 7 is further laminated on the adhesive layer 6 formed on the inorganic thin film layer 5, a load is applied to the inorganic thin film layer 5, and there is a risk that cracks, fissures and the like may occur in the inorganic thin film layer 5. Then, in the pressure-sensitive adhesive tape 1 containing such an inorganic thin film layer 5, moisture easily permeates into cracks and the like of the inorganic layer 5, and there is a concern that the moisture vapor transmission rate may increase.

In contrast, in the present embodiment, instead of directly laminating the adhesive layer 6 on the inorganic thin film layer 5, the adhesive layer 6 is laminated on the second substrate 7 to form the second laminated body 20, and then the first laminated body 10 and the second laminated body 20 are laminated to thereby form the composite substrate 2. Forming the composite substrate 2 by the steps described above makes it possible to suppress the load applied to the inorganic thin film layer 5 in the present embodiment, compared with the case where the adhesive layer 6 is directly formed on the inorganic thin film layer 5 as described above. As a result, the occurrence of cracks, fissures and the like in the inorganic thin film layer 5 can be suppressed, and it becomes possible to suppress the increase in the water vapor transmission rate of the pressure-sensitive adhesive tape 1.

### [Formation of Pressure-Sensitive Adhesive Layer]

Subsequently, to the composite substrate 2 after completion of aging, a pressure-sensitive adhesive composed of an acrylic copolymer resin and the like is applied on the first substrate 4 of the first laminated body 10 to form the pressure-sensitive adhesive layer 3. Specifically, for example, to a solution in which a pressure-sensitive adhesive composed, as a main component, of an acrylic copolymer and the like, is dissolved in an organic solvent such as ethyl acetate, toluene, or xylene is added a crosslinking agent to serve as a pressure-sensitive adhesive composition. Next, this pressure-sensitive adhesive composition is applied to the first substrate 4 of the composite substrate 2 with a comma coater, a lip coater, or the like so that the thickness after drying becomes uniform. Then, the applied pressure-sensitive adhesive composition is dried at a predetermined temperature to form the pressure-sensitive adhesive layer 3 on the composite substrate 2. By the above steps, the pressure-sensitive adhesive tape 1 (first embodiment) shown in FIG. 1 is obtained.

In general, when the pressure-sensitive adhesive layer is formed on the substrate using a comma coater, a lip coater, or the like to prepare a pressure-sensitive adhesive tape, the pressure-sensitive adhesive composition is applied while applying tension to the substrate. Here, if a thin film containing an inorganic substance such as the inorganic thin film layer 5 of the present embodiment is formed on the substrate, tension is applied to the substrate when the pressure-sensitive adhesive is applied, or a load is applied to the thin film by the contact of the thin film with the guide roll, so that cracks and the like may occur in the thin film. In the event of the occurrence of cracks and the like in the thin film, moisture easily permeates into the cracks and the like of the thin film, so that the water vapor transmission rate in the pressure-sensitive adhesive tape may increase.

On the other hand, the composite substrate 2 of the pressure-sensitive adhesive tape 1 of the present embodiment has a structure in which the inorganic thin film layer 5 is sandwiched between the first substrate 4 and the second substrate 7 via the adhesive layer 6. This makes it possible to protect the inorganic thin film layer 5 by the first substrate 4 and the second substrate 7, as well as possible to suppress the occurrence of cracks and the like in the inorganic thin film layer 5 even if tension is applied to the composite substrate 2 when the pressure-sensitive adhesive layer 3 is formed on the composite substrate 2, compared with the case of not having the present configuration. Then, by suppressing the occurrence of cracks and the like in the inorganic thin film layer 5, it becomes possible to suppress an increase in the water vapor transmission rate of the pressure-sensitive adhesive tape 1.

The pressure-sensitive adhesive tape 1 formed by the above steps is usually wound so that the pressure-sensitive adhesive layer 3 is on the inside. In the present embodiment, since the pressure-sensitive adhesive layer 3 is provided on the first substrate 4, in a state in which the pressure-sensitive adhesive tape 1 is wound up, the composite substrate 2 is wound up so that the first substrate 4 side is on the inside. Furthermore, in the step of forming the composite substrate 2 described above, when the first laminated body 10 is aged, the first laminated body 10 is wound up so that the first substrate 4 side is on the inside.

That is, in the present embodiment, a state in which the pressure-sensitive adhesive tape 1 produced is wound up, and a state in which the first laminated body 10 is wound up in the step of forming the composite substrate 2 are the same in the winding direction, and the winding direction of the inorganic thin film layer 5 provided on the first laminated body 10 in the manufacturing process of the pressure-sensitive adhesive tape 1 does not change. Here, for example, when the winding direction of the inorganic thin film layer 5 changes in the manufacturing process of the pressure-sensitive adhesive tape 1, there is a concern that a load may be applied to the inorganic thin film layer 5 to cause cracks, defects, or cracks. On the other hand, in the present embodiment, by adopting the configuration in which the winding direction of the inorganic thin film layer 5 is not changed in the manufacturing process of the pressure-sensitive adhesive tape 1, the load on the inorganic thin film layer 5 is suppressed, and it becomes possible to suppress the occurrence of cracks and the like in the inorganic thin film layer 5.

### (Method for Molding Plastic Lens Using Pressure-Sensitive Adhesive Tape)

As described above, the pressure-sensitive adhesive tape 1 of the present embodiment is used for molding plastic lenses used as, for example, spectacle lenses. Next, an example of a method for molding a plastic lens using the pressure-sensitive adhesive tape 1 of the present embodiment will be described.

FIG. 2 is a perspective view showing an example of the structure of glass molds used for the method for molding a plastic lens according to the present invention.

### [Cavity Forming Step]

First, as shown in FIG. 2, for example, a pair of molds 50 having a substantially disk-like shape are oppositely arranged at a predetermined interval, and then the pressure-sensitive adhesive tape 1 is stuck on outer peripheral edges of both the molds 50 so as to be wound along the circumferential direction. Then, while maintaining the interval between the molds 50, an opening of a space is formed between the molds 50 is continuously sealed. Thereby, as shown in FIG. 2, the molds 50 are connected substantially parallel to each other, and a compartment of a lens-shaped cavity C is formed between them. For the molds 50, those generally made of glass (silicon dioxide) or metal are commonly used, but the material of the molds 50 is not limited to these.

### [Resin-Filling Step]

After forming the cavity C between the molds 50, as shown in FIG. 2, one end of the pressure-sensitive adhesive tape 1 is peeled off to open the gap, and a nozzle (not shown) is inserted into the cavity C through the gap. Then, the liquid resin 100 is injected from the nozzle and filled into the cavity C. After that, the peeled pressure-sensitive adhesive tape 1 is returned to its original state to close the gap. The resin 100 to be injected/filled into the cavity C includes, for example, polymerizable monomers and/or polymerizable prepolymers supplemented with a polymerization initiator or a crosslinking agent.

### [Polymerization Step]

Next, the molds 50 obtained by winding the pressure-sensitive adhesive tape 1, and injecting the resin 100 into the cavity C are arranged in a polymerization furnace, and the resin 100 in the cavity C is polymerization reacted by heating or light irradiation to be cured. Then, after the resin 100 has been sufficiently cured, the pressure-sensitive adhesive tape 1 is completely peeled off and the molds 50 are removed to obtain a plastic lens. Here, as the brief temperature elevation process in the polymerization step by heating, it is preferred that the polymerization start temperature is 45° C. or higher and 65° C. or lower, and the temperature elevation rate until reaching the final curing temperature of 130° C. or higher and 150° C. or lower is 0.10° C./min or more and 0.45° C./min or less. If the polymerization start temperature, the final curing temperature, and the temperature elevation rate are within the above ranges, the quality of the obtained high refractive index plastic lens can be maintained at a problem-free level even in the brief temperature elevation process.

The plastic lens formed in the present embodiment is used as, for example, a spectacle lens. Here, as the resin 100 (polymerizable monomers or polymerizable prepolymers) used for molding plastic lenses, conventionally known materials may be used. For example, when forming a spectacle lens with an ultra-high refractive index (refractive coefficient: 1.65 or more), monomers, prepolymers and the like of an episulfide-based resin (MR-174 (trade name) manufactured by Mitsui Chemicals, Inc., IU-20 (trade name) manufactured by MITSUBISHI GAS CHEMICAL COMPANY, INC.), and a thiourethane-based resin (MR-7 (trade name) manufactured by Mitsui Chemicals, Inc.) are used.

When forming a spectacle lens having a high refractive index (refractive index: 1.59 or more and less than 1.65), monomers, prepolymers, and the like of a thiourethane-based resin (MR-6 (trade name) manufactured by Mitsui Chemicals Inc., MR-8 (trade name) manufactured by Mitsui Chemicals Inc.), polyester methacrylate (TS-26 (trade name) manufactured by Tokuyama Corporation), and polycarbonate (Panlite (trade name) manufactured by Teijin Chemicals Ltd.), are used.

Conventionally, in the polymerization process in the plastic lens manufacturing process, moisture in outdoor air permeated through the pressure-sensitive adhesive tape 1 and entered the cavity C. Then, moisture was mixed into the resin 100 and reacted with, for example, a crosslinking agent added to the resin 100 to generate a gas or the like. As a result, voids were formed in the plastic lens, and bubbles occurred or whitening occurred in the obtained plastic lens. Here, if voids in the plastic lenses formed by mixing of moisture in outdoor air into the resin 100 are large, bubbles occur mainly on the peripheral edge of the plastic lens, and when voids are small, whitening occurs mainly in a central portion of the lens.

In particular, as in the thiourethane-based resin, when the isocyanate-based curing agent is used for curing the resin 100, an isocyanate group (NCO group) in the resin 100 reacts with moisture mixed into the resin 100 to generate CO₂ gas as a by-product. Formation of voids due to the CO₂ gas sometimes led to the occurrence of bubbles or whitening in the plastic lens.

Comparatively speaking, in the pressure-sensitive adhesive tape 1 of the present embodiment, the inorganic thin film layer 5 for suppressing the permeation of moisture in the pressure-sensitive adhesive tape 1. The pressure-sensitive adhesive tape 1 has a structure in which the inorganic thin film layer 5 is sandwiched between the first base material 4 and the second base material 7 via the adhesive layer 6. With such a structure, in the pressure-sensitive adhesive tape 1 of the present embodiment, the inorganic thin film layer 5 is protected by the first substrate 4 and the second substrate 7, cracks and the like are unlikely to occur in the inorganic thin film layer 5 in the manufacturing process of the pressure-sensitive adhesive tape 1 and the manufacturing process of the plastic lens.

Thereby, in the present embodiment, it becomes possible to suppress moisture in outdoor air permeating through the pressure-sensitive adhesive tape 1 and entering the cavity C due to cracks in the inorganic thin film layer 5 in the manufacturing process of the plastic lens.

As a result, in the formed plastic lenses, it becomes possible to suppress the occurrence of bubbles and whitening caused by mixing of moisture into the resin 100 in the cavity C.

### EXAMPLES

Subsequently, the present invention will be described in more detail using Examples and Comparative Examples. The present invention is not limited to the following Examples.

Hereinafter, each Example and each Comparative Example will be described in detail.

### 1. Preparation of Pressure-Sensitive Adhesive Tape 1 and Molding of Plastic Lens

### Example 1

A first laminated body 10 (TECH BARRIER LX (trade name) manufactured by Mitsubishi Chemical Holdings Corporation), in which an inorganic thin film layer 5 obtained by vapor-depositing silica was laminated on a polyester film having a thickness of 12 μm as a first substrate 4, and a second laminated body in which a polyester-based adhesive having a thickness of 1 μm as an adhesive layer 6 (Takelac A-310/Takenate A-3 (trade name) manufactured by Mitsubishi Chemical Holdings Corporation) was laminated on a polyester film having a thickness of 25 μm as a second substrate 7 (manufactured by Mitsubishi Chemical Holdings Corporation) were laminated so that the inorganic thin film layer 5 and the adhesive layer 6 faced each other to form a composite substrate 2.

A solution of a pressure-sensitive adhesive composed of an acrylic copolymer A1 (dodecyl methacrylate/acrylic acid/vinyl acetate=78% by mass/2% by mass/20% by mass, acid value 14.8 mgKOH/g) in ethyl acetate/toluene (solid content concentration: 40% by mass) was prepared. The acrylic copolymer A1 had a weight-average molecular weight (Mw) in terms of polystyrene of 1,320,000, as measured by gel permeation chromatography, and a polydispersity (M_{w}/Mₙ) of 9.3. The glass transition temperature Tg calculated from Fox's formula was −49° C.

Subsequently, 6.8 parts by mass (3.0 parts by mass in terms of solid content, equivalent ratio of NCO/COOH=0.49) of a polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained.

Then, using the formed pressure-sensitive adhesive tape 1, two types of thiourethane-based plastic lenses PL1 and PL2 having different refractive indices were molded by the method shown in FIG. 2. A mixture of 56.48 parts by mass of pentaerythritol tetrakis mercaptopropionate and 43.52 parts by mass of m-xylylene diisocyanate was used as a main raw material of a molding resin for the plastic lens PL1. As additives, 0.007 parts by mass of a tin-based catalyst, 0.14 parts by mass of an acidic phosphate ester-based internal mold release agent, and 0.10 parts by mass of a benzotriazole-based ultraviolet absorber were used. After stirring and mixing m-xylylene diisocyanate and the additives under reduced pressure, pentaerythritol tetrakis mercaptopropionate was added, and the mixture was slowly stirred and mixed at 60° C. under reduced pressure. When the viscosity reached 200 cps (23° C.), stirring and mixing were terminated to prepare a resin composition for molding the plastic lens PL1. A mixture of 48.09 parts by mass of 2,3-bis (2-mercaptoethylthio) propane-1-thiol and 51.91 parts by mass of m-xylylene diisocyanate was used as a main raw material of a molding resin for the plastic lens PL2. As additives, 0.007 parts by mass of a tin-based catalyst, 0.14 parts by mass of an acidic phosphate ester-based internal mold release agent, and 0.10 parts by mass of a benzotriazole-based ultraviolet absorber were used. After stirring and mixing m-xylylene diisocyanate and the additives under reduced pressure, 2,3-bis (2-mercaptoethylthio) propane-1-thiol was added, and the mixture was slowly stirred and mixed at 60° C. under reduced pressure. When the viscosity reached 200 cps (23° C.), stirring and mixing were terminated to prepare a resin composition for molding the plastic lens PL2. The polymerization start temperature was set to 60° C., which was raised to a final polymerization temperature of 130° C. over 10 hours (temperature elevation rate: 0.12° C./min), samples were held at 130° C. for 5 hours, and then cooled to 60° C. over 2 hours, to obtain the thiourethane-based plastic lens PL1 (refractive index 1.60) and the thiourethane-based plastic lens PL2 (refractive index 1.67).

### Example 2

A solution of a pressure-sensitive adhesive composed of an acrylic copolymer A2 (dodecyl methacrylate/acrylic acid/vinyl acetate=78% by mass/2% by mass/20% by mass, acid value 14.9 mgKOH/g) (solid content concentration: 40% by mass) in ethyl acetate/toluene was prepared. The acrylic copolymer A2 had a weight-average molecular weight (Mw) in terms of polystyrene of 1,100,000, as measured by gel permeation chromatography, and a polydispersity (M_{w}/Mₙ) of 9.8. The glass transition temperature Tg calculated from Fox's formula was −49° C.

Subsequently, 6.8 parts by mass (3.0 parts by mass in terms of solid content, equivalent ratio of NCO/COOH=0.49) of the polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Example 3

A solution of a pressure-sensitive adhesive composed of an acrylic copolymer A3 (dodecyl methacrylate/acrylic acid/vinyl acetate=78% by mass/2% by mass/20% by mass, acid value 14.5 mgKOH/g) in ethyl acetate/toluene (solid content concentration: 40% by mass) was prepared. The acrylic copolymer A3 had a weight-average molecular weight (M_{w}) in terms of polystyrene of 1,380,000, as measured by gel permeation chromatography, and a polydispersity (M_{w}/Mₙ) of 9.5. The glass transition temperature Tg calculated from Fox's formula was −49° C.

Subsequently, 6.8 parts by mass (3.0 parts by mass in terms of solid content, equivalent ratio of NCO/COOH=0.50) of the polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Example 4

A pressure-sensitive adhesive tape 1 and plastic lenses were obtained in the same manner as in Example 1 except that the amount of the polyisocyanate-based crosslinking agent “Coronate L-45” (trade name, solid content concentration 45% by mass, NCO content 8% by mass) manufactured by Soken Chemical and Engineering Co., Ltd.) was changed to 5.0 parts by mass (2.3 parts by mass in terms of solid content, equivalent ratio of NCO/COOH=0.36).

### Example 5

A pressure-sensitive adhesive tape 1 and plastic lenses were obtained in the same manner as in Example 1 except that the amount of the polyisocyanate-based crosslinking agent “Coronate L-45” (trade name, solid content concentration 45% by mass, NCO content 8% by mass) manufactured by Soken Chemical and Engineering Co., Ltd.) was changed to 8.3 parts by mass (3.7 parts by mass in terms of solid content, equivalent ratio of NCO/COOH=0.60).

### Example 6

A pressure-sensitive adhesive tape 1 and plastic lenses were obtained in the same manner as in Example 1 except that the amount of the polyisocyanate-based crosslinking agent “Coronate L-45” (trade name, solid content concentration 45% by mass, NCO content 8% by mass) manufactured by Soken Chemical and Engineering Co., Ltd.) was changed to 3.2 parts by mass (1.4 parts by mass in terms of solid content, equivalent ratio of NCO/COOH=0.23).

### Example 7

A pressure-sensitive adhesive tape 1 and plastic lenses were obtained in the same manner as in Example 1 except that the amount of the polyisocyanate-based crosslinking agent “Coronate L-45” (trade name, solid content concentration 45% by mass, NCO content 8% by mass) manufactured by Soken Chemical and Engineering Co., Ltd.) was changed to 10.0 parts by mass (4.5 parts by mass in terms of solid content, equivalent ratio of NCO/COOH=0.72).

### Example 8

A solution of a pressure-sensitive adhesive composed of an acrylic copolymer B (dodecyl methacrylate/acrylic acid/vinyl acetate=79% by mass/1% by mass/20% by mass, acid value 7.5 mgKOH/g) in ethyl acetate/toluene (solid content concentration: 40% by mass) was prepared. The acrylic copolymer B had a weight-average molecular weight (M_{w}) in terms of polystyrene of 1,350,000, as measured by gel permeation chromatography, and a polydispersity (M_{w}/Mₙ) of 9.2. The glass transition temperature Tg calculated from Fox's formula was −50° C.

Subsequently, 5.3 parts by mass (2.4 parts by mass in terms of solid content, equivalent ratio of NCO/COOH=0.75) of the polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Example 9

A solution of a pressure-sensitive adhesive composed of an acrylic copolymer C (dodecyl methacrylate/acrylic acid/vinyl acetate=75% by mass/5% by mass/20% by mass, acid value 37.1 mgKOH/g) in ethyl acetate/toluene (solid content concentration: 40% by mass) was prepared. The acrylic copolymer C had a weight-average molecular weight (M_{w}) in terms of polystyrene of 1,150,000, as measured by gel permeation chromatography, and a polydispersity (M_{w}/Mₙ) of 9.7. The glass transition temperature Tg calculated from Fox's formula was −45° C.

Subsequently, 10.1 parts by mass (4.5 parts by mass in terms of solid content, equivalent ratio of NCO/COOH=0.29) of the polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Example 10

A solution of a pressure-sensitive adhesive composed of an acrylic copolymer D (dodecyl acrylate/2-ethyl hexyl acrylate/acrylic acid=78% by mass/20% by mass/2% by mass, acid value 14.9 mgKOH/g) in ethyl acetate/toluene (solid content concentration: 40% by mass) was prepared. The acrylic copolymer D had a weight-average molecular weight (M_{w}) in terms of polystyrene of 1,200,000, as measured by gel permeation chromatography, and a polydispersity (M_{w}/Mₙ) of 9.7. The glass transition temperature Tg calculated from Fox's formula was −22° C.

Subsequently, 6.8 parts by mass (3.0 parts by mass in terms of solid content, equivalent ratio of NCO/COOH=0.49) of the polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Example 11

A solution of a pressure-sensitive adhesive composed of an acrylic copolymer E (isodecyl methacrylate/acrylic acid/vinyl acetate=78% by mass/2% by mass/20% by mass, acid value 14.6 mgKOH/g) in ethyl acetate/toluene (solid content concentration: 40% by mass) was prepared. The acrylic copolymer E had a weight-average molecular weight (M_{w}) in terms of polystyrene of 1,360,000, as measured by gel permeation chromatography, and a polydispersity (M_{w}/Mₙ) of 9.2. The glass transition temperature Tg calculated from Fox's formula was −27° C.

Subsequently, 6.8 parts by mass (3.0 parts by mass in terms of solid content, equivalent ratio of NCO/COOH=0.50) of the polyisocyanate-based crosslinking agent “Coronate L-45” (trade name, solid content concentration: 45% by mass, NCO content: 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Example 12

A solution of a pressure-sensitive adhesive composed of an acrylic copolymer F (tetradecyl methacrylate/2-ethyl hexyl acrylate/acrylic acid=88% by mass/10% by mass/2% by mass, acid value 14.9 mgKOH/g) in ethyl acetate/toluene (solid content concentration: 40% by mass) was prepared. The acrylic copolymer F had a weight-average molecular weight (M_{w}) in terms of polystyrene of 1,100,000, as measured by gel permeation chromatography, and a polydispersity (M_{w}/Mₙ) of 10.0. The glass transition temperature Tg calculated from Fox's formula was −20° C.

Subsequently, 5.0 parts by mass (2.3 parts by mass in terms of solid content, equivalent ratio of NCO/COOH=0.36) of the polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Example 13

A solution of a pressure-sensitive adhesive composed of an acrylic copolymer G (2-ethyl hexyl acrylate/acrylic acid/vinyl acetate=83% by mass/2% by mass/15% by mass, acid value 15.0 mgKOH/g) in ethyl acetate/toluene (solid content concentration: 40% by mass) was prepared. The acrylic copolymer G had a weight-average molecular weight (M_{w}) in terms of polystyrene of 1,380,000, as measured by gel permeation chromatography, and a polydispersity (M_{w}/Mₙ) of 10.0. The glass transition temperature Tg calculated from Fox's formula was −57° C.

Subsequently, 8.3 parts by mass (3.7 parts by mass in terms of solid content, equivalent ratio of NCO/COOH=0.59) of the polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Example 14

A solution of a pressure-sensitive adhesive composed of an acrylic copolymer H (dodecyl methacrylate/2-hydroxylethyl acrylate/vinyl acetate=83% by mass/2% by mass/15% by mass, hydroxyl value 10.0 mgKOH/g) in ethyl acetate/toluene (solid content concentration: 40% by mass) was prepared. The acrylic copolymer H had a weight-average molecular weight (M_{w}) in terms of polystyrene of 1,420,000, as measured by gel permeation chromatography, and a polydispersity (M_{w}/Mₙ) of 9.8. The glass transition temperature Tg calculated from Fox's formula was −54° C.

Subsequently, 5.0 parts by mass (2.3 parts by mass in terms of solid content, equivalent ratio of NCO/OH=0.53) of the polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Comparative Example 1

A solution of a pressure-sensitive adhesive composed of an acrylic copolymer I (n-butyl acrylate/methyl acrylate/2-hydroxyethyl acrylate=85% by mass/10% by mass/5% by mass, hydroxyl value 24.0 mgKOH/g) in ethyl acetate (solid content concentration: 30% by mass) was prepared. The acrylic copolymer I had a weight-average molecular weight (M_{W}) in terms of polystyrene of 753,000, as measured by gel permeation chromatography, and a polydispersity (M_{w}/Mₙ) of 17.1. The glass transition temperature Tg calculated from Fox's formula was −48° C.

Subsequently, 6.7 parts by mass (3.0 parts by mass in terms of solid content, equivalent ratio of NCO/OH=0.30) of the polyisocyanate-based crosslinking agent “Coronate L-45” (trade name, solid content concentration 45% by mass, NCO content 8% by mass) manufactured by Soken Chemical and Engineering Co., Ltd.) was blended with 333 parts by mass (100 parts by mass in terms of solid content) of the pressure-sensitive adhesive solution by using a disper to prepare a pressure-sensitive adhesive solution for coating (solid content concentration: 30% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Comparative Example 2

A solution of a pressure-sensitive adhesive composed of an acrylic copolymer I (n-butyl acrylate/methyl acrylate/2-hydroxyethyl acrylate=85% by mass/10% by mass/5% by mass, hydroxyl value 24.0 mgKOH/g) in ethyl acetate (solid content concentration: 30% by mass) was prepared. The acrylic copolymer I had a weight-average molecular weight (M_{w}) in terms of polystyrene of 753,000, as measured by gel permeation chromatography, and a polydispersity (M_{w}/Mₙ) of 17.1. The glass transition temperature Tg calculated from Fox's formula was −48° C.

Subsequently, 11.2 parts by mass (5.0 parts by mass in terms of solid content, equivalent ratio of NCO/OH=0.50) of the polyisocyanate-based crosslinking agent “Coronate L-45” (trade name, solid content concentration 45% by mass, NCO content 8% by mass) manufactured by Soken Chemical and Engineering Co., Ltd.) was blended with 333 parts by mass (100 parts by mass in terms of solid content) of the pressure-sensitive adhesive solution by using a disper to prepare a pressure-sensitive adhesive solution for coating (solid content concentration: 30% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Comparative Example 3

A solution of a pressure-sensitive adhesive composed of an acrylic copolymer J (2-ethylhexyl acrylate/acrylic acid/vinyl acetate=89.5% by mass/0.5% by mass/10% by mass, acid value 3.8 mgKOH/g) in ethyl acetate/toluene (solid content concentration: 30% by mass) was prepared. The acrylic copolymer J had a weight-average molecular weight (M_{w}) in terms of polystyrene of 1,020,000, as measured by gel permeation chromatography, and a polydispersity (M_{w}/Mₙ) of 31.2. The glass transition temperature Tg calculated from Fox's formula was −63° C.

Subsequently, 3.3 parts by mass (1.5 parts by mass in terms of solid content, equivalent ratio of NCO/COOH=1.07) of the polyisocyanate-based crosslinking agent “Coronate L-45” (trade name, solid content concentration 45% by mass, NCO content 8% by mass) manufactured by Soken Chemical and Engineering Co., Ltd.) was blended with 333 parts by mass (100 parts by mass in terms of solid content) of the pressure-sensitive adhesive solution by using a disper to prepare a pressure-sensitive adhesive solution for coating (solid content concentration: 30% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Comparative Example 4

A solution of a pressure-sensitive adhesive composed of an acrylic copolymer K (n-butyl acrylate/methyl acrylate/2-hydroxyethyl acrylate=50% by mass/45% by mass/5% by mass) in ethyl acetate/toluene (solid content concentration: 30% by mass) was prepared. The acrylic copolymer K had a weight-average molecular weight (M_{w}) in terms of polystyrene of 672,000, as measured by gel permeation chromatography, and a polydispersity (M_{w}/Mₙ) of 18.2. The glass transition temperature Tg calculated from Fox's formula was −28° C.

Subsequently, 3.3 parts by mass (1.5 parts by mass in terms of solid content, equivalent ratio of NCO/OH=0.15) of the polyisocyanate-based crosslinking agent “Coronate L-45” (trade name, solid content concentration 45% by mass, NCO content 8% by mass) manufactured by Soken Chemical and Engineering Co., Ltd.) was blended with 333 parts by mass (100 parts by mass in terms of solid content) of the pressure-sensitive adhesive solution by using a disper to prepare a pressure-sensitive adhesive solution for coating (solid content concentration: 30% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained. Then, plastic lenses were obtained in the same manner as in Example 1.

### Comparative Example 5

A solution of a pressure-sensitive adhesive composed of an acrylic copolymer A4 (dodecyl methacrylate/acrylic acid/vinyl acetate=78% by mass/2% by mass/20% by mass, acid value 14.8 mgKOH/g) in ethyl acetate/toluene (solid content concentration: 40% by mass) was prepared. The acrylic copolymer A4 had a weight-average molecular weight (M_{w}) in terms of polystyrene of 1,240,000, as measured by gel permeation chromatography, and a polydispersity (M_{w}/Mₙ) of 16.7. The glass transition temperature Tg calculated from Fox's formula was −49° C.

Subsequently, 3.2 parts by mass (1.4 parts by mass in terms of solid content, equivalent ratio of NCO/COOH=0.23) of the polyisocyanate-based crosslinking agent “Coronate L-45” (trade name, solid content concentration 45% by mass, NCO content 8% by mass) manufactured by Soken Chemical and Engineering Co., Ltd.) was blended with 250 parts by mass (100 parts by mass in terms of solid content) of the pressure-sensitive adhesive solution by using a disper to prepare a pressure-sensitive adhesive solution for coating (solid content concentration: 40% by mass).

Subsequently, this pressure-sensitive adhesive solution for coating was coated on the first substrate 4 of the composite substrate 2, which was then heated at a temperature of 110° C. for 3 minutes to form a pressure-sensitive adhesive layer 3 with a thickness after drying of 30 μm. Thereby, a pressure-sensitive adhesive tape 1 with a total thickness after drying of 68 μm was obtained.

### Comparative Example 6

A pressure-sensitive adhesive tape 1 and plastic lenses were obtained in the same manner as in Example 1 except that the amount of the polyisocyanate-based crosslinking agent “Coronate L-45” (trade name, solid content concentration 45% by mass, NCO content 8% by mass) manufactured by Soken Chemical and Engineering Co., Ltd.) was changed to 11.7 parts by mass (5.3 parts by mass in terms of solid content, equivalent ratio of NCO/COOH=0.84).

### Comparative Example 7

A pressure-sensitive adhesive tape 1 and plastic lenses were obtained in the same manner as in Example 1 except that the amount of the polyisocyanate-based crosslinking agent “Coronate L-45” (trade name, solid content concentration 45% by mass, NCO content 8% by mass) manufactured by Soken Chemical and Engineering Co., Ltd.) was changed to 2.6 parts by mass (1.2 parts by mass in terms of solid content, equivalent ratio of NCO/COOH=0.19).

### 2. Evaluation Method

### (1) Evaluation Method of Pressure-Sensitive Adhesive Tape 1

### (1-1) Adhesive-force Test

An adhesive-force test on polished SUS (peel adhesive-force test) was conducted on pressure-sensitive adhesive tapes 1 produced in Examples 1 to 14 and Comparative Examples 1 to 7 under the temperature condition of 23° C. in accordance with the method described in JIS Z 0237 (2009).

Specifically, the pressure-sensitive adhesive tape 1 was stuck on a polished stainless steel plate (SUS 304). A roller with a mass of 2 kg was reciprocated once at a speed of 5 mm/sec, followed by contact bonding. Then, after being left to stand for 20 to 40 minutes, using a tensile tester, it was peeled off at a speed of 5 mm/sec in the 180° direction with respect to the stainless steel plate, and the adhesive force on the polished SUS plate was measured.

### (1-2) Holding Force Test

An adhesive-force test on polished SUS (peel adhesive-force test) was conducted on pressure-sensitive adhesive tapes 1 produced in Examples 1 to 14 and Comparative Examples 1 to 7 under the temperature condition of 23° C. in accordance with the method described in JIS Z 0237 (2009). Specifically, a pressure-sensitive adhesive layer with an area of 25 mm×25 mm was stuck on a polished SUS plate (SUS304) so that an end in the length direction of the pressure-sensitive adhesive tape 1 protruded. Then a roller with a mass of 2 kg was reciprocated once at a speed of 5 mm/sec, followed by contact bonding. Subsequently, after 20 to 40 minutes have elapsed since the pressure-sensitive adhesive tape 1 was contact-bonded, under the temperature condition of 40° C., a weight with a mass of 1 kg was attached to the end of the pressure-sensitive adhesive tape 1. Then, the elapsed time from when the weight was attached until the pressure-sensitive adhesive tape 1 was completely peeled off from the polished SUS plate, or the shift length (mm) of the pressure-sensitive adhesive tape 1 after 24 hours have elapsed was measured.

### (1-3) Creep Test

For the pressure-sensitive adhesive tapes 1 produced in Examples 1 to 14 and Comparative Examples 1 to 7 under the temperature condition of 23° C., a pressure-sensitive adhesive layer with an area of 25 mm×25 mm was stuck on a polished SUS plate (SUS304) so that an end in the length direction of the pressure-sensitive adhesive tape 1 protruded. Then a roller with a mass of 2 kg was reciprocated once at a speed of 5 mm/sec, followed by contact bonding. Subsequently, after 20 to 40 minutes have elapsed since the pressure-sensitive adhesive tape 1 was contact-bonded, test pieces were hung on a recordable creep tester capable of hanging six at a time, the temperature of which being adjusted to 40° C. (manufactured by Toyo Seiki Seisakusho, Ltd, Model C100-6), a load with a mass of 0.5 kg was applied. Then, a creep test was conducted by measuring the shift length (mm) after 800 minutes. The average value of the 6 test pieces served as the shift length.

### (1-4) Measurement of Elution Percentage of Pressure-Sensitive Adhesive Layer

The pressure-sensitive adhesive tapes 1 produced in Examples 1 to 14 and Comparative Examples 1 to 7 were cut to an area of 25 mm×25 mm to serve as test pieces. Subsequently, the they were immersed for 2 hours in toluene the temperatures of which being adjusted to 20° C. and 80° C., the weight before and after immersion was measured, and the elution percentage in toluene at each temperature was measured by the following equation (1).

Elution Percentage (%)={1−[(W₂−W₀)/(W₁−W₀)]}×100 (1)

(W₀: weight of substrate, W₁: weight of test piece before immersion, W₂: weight of test piece after immersion and drying)

### (2) Evaluation of Plastic Lenses

The plastic lenses PL1 and PL2 produced using the pressure-sensitive adhesive tapes 1 prepared in Examples 1 to 14 and Comparative Examples 1 to 7 were visually observed and evaluated for the presence or absence of the occurrence of whitening, wrinkles, and bubbles. In addition, for the presence or absence of pressure-sensitive adhesive residues on the molds and the side surface of the plastic lens after the pressure-sensitive adhesive tape 1 has been peeled off, they were visually observed and evaluated. The whitening of the plastic lens refers to a state in which the plastic lens looks white and turbid when the plastic lens is irradiated with light. The evaluation regarding the occurrence of whitening, wrinkles, and bubbles on the plastic lens, and the occurrence of the pressure-sensitive adhesive residues on the molds and the side surface of the plastic lens were conducted according to the following criteria.

### (Occurrence of Whitening)

A: No whitening is observed.
B: Whitening is slightly observed on the outer peripheral edge of the plastic lens.
C: Whitening is clearly observed on the outer peripheral edge of the plastic lens.

### (Occurrence of Bubbles)

A: No bubbles are observed.
B: Bubbles are slightly observed on the outer peripheral edge of the plastic lens.
C: Bubbles are clearly observed on the outer peripheral edge of the plastic lens.

### (Occurrence of Wrinkles)

A: No wrinkles are observed.
B: Wrinkles are slightly observed on the side surface of the plastic lens.
C: Wrinkles are clearly observed on the side surface the plastic lens.

### (Occurrence of Pressure-Sensitive Adhesive Residue)

A: No pressure-sensitive adhesive residue is observed.
B: Pressure-sensitive adhesive residue is slightly observed on the side surface of the mold and/or the plastic lens.
C: Pressure-sensitive adhesive residues is clearly observed on the side surface of the mold and/or the plastic lens.

In every test, it was determined that the evaluation of A or B was at a level having no problem in practical use.

### 3. Test Results

Tables 1 to 4 show the evaluation results for the pressure-sensitive adhesive tapes 1 of Examples 1 to 14 and Comparative Examples 1 to 7.

TABLE 1

| Item | | | | Example 1 | Example 2 | Example 3 | Example 4 | Example 5 | Example 6 |
|---|---|---|---|---|---|---|---|---|---|
| Pressure- | Acrylic | Type | | A-1 | A-2 | A-3 | A-1 | A-1 | A-1 |
| sensitive | copolymer | | | dodecyl | dodecyl | dodecyl | dodecyl | dodecyl | dodecyl |
| adhesive | | | | metha- | metha- | metha- | metha- | metha- | metha- |
| layer | | | | crylate/ | crylate/ | crylate/ | crylate/ | crylate/ | crylate/ |
| | | | | acrylic | acrylic | acrylic | acrylic | acrylic | acrylic |
| | | | | acid/vinyl | acid/vinyl | acid/vinyl | acid/vinyl | acid/vinyl | acid/vinyl |
| | | | | acetate | acetate | acetate | acetate | acetate | acetate |
| | | | | copolymer | copolymer | copolymer | copolymer | copolymer | copolymer |
| | | Composition of | methyl acrylate | — | — | — | — | — | — |
| | | co-polymer | (C number of alkyl | | | | | | |
| | | (% by mass) | group: 1) | | | | | | |
| | | | butyl acrylate (C | — | — | — | — | — | — |
| | | | number of alkyl | | | | | | |
| | | | group: 4) | | | | | | |
| | | | 2-ethyl hexyl | — | — | — | — | — | — |
| | | | acrylate (C number | | | | | | |
| | | | of alkyl group: 8) | | | | | | |
| | | | isodecyl methacrylate | — | — | — | — | — | — |
| | | | (C number of alkyl | | | | | | |
| | | | group: 10) | | | | | | |
| | | | dodecyl acrylate (C | — | — | — | — | — | — |
| | | | number of alkyl | | | | | | |
| | | | group: 12) | | | | | | |
| | | | dodecyl methacrylate | 78 | 78 | 78 | 78 | 78 | 78 |
| | | | (C number of alkyl | | | | | | |
| | | | group: 12) | | | | | | |
| | | | tetradecyl | — | — | — | — | — | — |
| | | | methacrylate (C | | | | | | |
| | | | number of alkyl | | | | | | |
| | | | group: 14) | | | | | | |
| | | | acrylic acid | 2 | 2 | 2 | 2 | 2 | 2 |
| | | | 2-hydroxyethyl | — | — | — | — | — | — |
| | | | acrylate | | | | | | |
| | | | vinyl acetate | 20 | 20 | 20 | 20 | 20 | 20 |

| | | Weight-average | 1,320,000 | 1,100,000 | 1,380,000 | 1,320,000 | 1,320,000 | 1,320,000 |
|---|---|---|---|---|---|---|---|---|
| | | molecular weight (M_{w}) | | | | | | |
| | | Polydispersity (M_{w}/Mₙ) | 9.3 | 9.8 | 9.5 | 9.3 | 9.3 | 9.3 |
| | | Acid value (mgKOH/g) | 14.8 | 14.9 | 14.5 | 14.8 | 14.8 | 14.8 |
| | | Hydroxyl value (mgKOH/g) | — | — | — | — | — | — |
| | | Tg (° C.) | −49 | −49 | −49 | −49 | −49 | −49 |
| | Blending amount of acrylic | | 100 | 100 | 100 | 100 | 100 | 100 |
| | copolymer (parts by mass) | | | | | | | |
| | Blending amount of | | 3.0 | 3.0 | 3.0 | 2.3 | 3.7 | 1.4 |
| | crosslinking agent (parts by mass) | | | | | | | |
| | NCO/COOH equivalent ratio | | 0.49 | 0.49 | 0.50 | 0.36 | 0.60 | 0.23 |
| | NCO/OH equivalent ratio | | — | — | — | — | — | — |
| Evalu- | Adhesive force on | | 2.7 | 2.7 | 2.7 | 2.9 | 3.1 | 3.2 |
| ation | stainless steel (N/10 mm) | | | | | | | |
| results | Holding force on stainless | | 1.0 (shift | 0.9 (shift | 1.1 (shift | 1.2 (shift | 0.4 (shift | 1.3 (shift |
| | steel (shift length mm or fallen) | | length) | length) | length) | length) | length) | length) |
| | Creep characteristics | | 0.35 | 0.32 | 0.3.4 | 0.40 | 0.25 | 0.45 |
| | (shift length mm) | | | | | | | |
| | Elution | 20° C. toluene | 19.6 | 19.9 | 19.9 | 21.1 | 18.9 | 24.4 |
| | percentage | 80° C. toluene | | | | | | |
| | of pressure- | | 29.6 | 30.6 | 31.1 | 35.0 | 27.8 | 47.7 |
| | sensitive | | | | | | | |
| | adhesive (%) | | | | | | | |
| | Plastic | occurrence of whitening | A | A | A | A | A | A |
| | lens PL 1 | occurrence of wrinkles | A | A | A | A | A | A |
| | | occurrence of bubbles | A | A | A | A | A | A |
| | | occurrence of residues | A | A | A | A | A | A |
| | Plastic | occurrence of whitening | A | A | A | A | A | A |
| | lens PL 2 | occurrence of wrinkles | A | A | A | A | A | A |
| | | occurrence of bubbles | A | A | A | A | A | A |
| | | occurrence of residues | A | A | A | A | A | A |

TABLE 2

| Item | | | | Example 7 | Example 8 | Example 9 | Example 10 | Example 11 | Example 12 |
|---|---|---|---|---|---|---|---|---|---|
| Pressure- | Acrylic | Type | | A-1 | B | C | D | E | F |
| sensitive | copolymer | | | dodecyl | dodecyl | dodecyl | dodecyl | dodecyl | dodecyl |
| adhesive | | | | metha- | metha- | metha- | metha - | metha- | metha- |
| layer | | | | crylate/ | crylate/ | crylate/ | crylate/ | crylate/ | crylate/ |
| | | | | acrylic | acrylic | acrylic | acrylic | acrylic | acrylic |
| | | | | acid/vinyl | acid/vinyl | acid/vinyl | acrylate/ | acid/vinyl | acrylate/ |
| | | | | acetate | acetate | acetate | acrylic acid | acetate | acrylic acid |
| | | | | copolymer | copolymer | copolymer | copolymer | copolymer | copolymer |
| | | Composition of | methyl acrylate | — | — | — | — | — | — |
| | | co-polymer | (C number of alkyl | | | | | | |
| | | (% by mass) | group: 1) | | | | | | |
| | | | butyl acrylate (C | — | — | — | — | — | — |
| | | | number of alkyl | | | | | | |
| | | | group: 4) | | | | | | |
| | | | 2-ethyl hexyl acrylate | — | — | — | 20 | — | 10 |
| | | | (C number of alkyl | | | | | | |
| | | | group: 8) | | | | | | |
| | | | isodecyl methacrylate | — | — | — | — | 78 | — |
| | | | (C number of alkyl | | | | | | |
| | | | group: 10) | | | | | | |
| | | | dodecyl acrylate (C | — | — | — | 78 | — | — |
| | | | number of alkyl | | | | | | |
| | | | group: 12) | | | | | | |
| | | | dodecyl methacrylate | 78 | 79 | 75 | — | — | — |
| | | | (C number of alkyl | | | | | | |
| | | | group: 12) | | | | | | |
| | | | tetradecyl | — | — | — | — | — | 88 |
| | | | methacrylate (C | | | | | | |
| | | | number of alkyl | | | | | | |
| | | | group: 14) | | | | | | |
| | | | acrylic acid | 2 | 1 | 5 | 2 | 2 | 2 |
| | | | 2-hydroxyethyl | — | — | — | — | — | — |
| | | | acrylate | | | | | | |
| | | | vinyl acetate | 20 | 20 | 20 | — | 20 | — |

| | | Weight-average | 1,320,000 | 1,350,000 | 1,150,000 | 1,200,000 | 1,360,000 | 1,110,000 |
|---|---|---|---|---|---|---|---|---|
| | | molecular weight (M_{w}) | | | | | | |
| | | Polydispersity (M_{w}/Mₙ) | 9.3 | 9.2 | 9.7 | 9.7 | 9.2 | 10.0 |
| | | Acid value (mgKOH/g) | 14.6 | 7.5 | 37.1 | 14.9 | 14.6 | 14.9 |
| | | Hydroxyl value (mgKOH/g) | — | — | — | — | — | — |
| | | Tg (° C.) | −49 | −50 | −45 | −22 | −27 | −20 |
| | Blending amount of acrylic | | 100 | 100 | 100 | 100 | 100 | 100 |
| | copolymer (parts by mass) | | | | | | | |
| | Blending amount of | | 4.5 | 2.4 | 4.5 | 3.0 | 3.0 | 2.3 |
| | crosslinking agent (parts by mass) | | | | | | | |
| | NCO/COOH equivalent ratio | | 0.72 | 0.75 | 0.29 | 0.49 | 0.50 | 0.36 |
| | NCO/OH equivalent ratio | | — | — | — | — | — | — |
| Evalu- | Adhesive force on | | 3.2 | 3.0 | 3.8 | 2.7 | 2.7 | 2.8 |
| ation | stainless steel (N/10 mm) | | | | | | | |
| results | Holding force on stainless | | 0.2 (shift | 1.0 (shift | 0.2 (shift | 0.4 (shift | 0.5 (shift | 1.0 (shift |
| | steel (shift length mm or fallen) | | length) | length) | length) | length) | length) | length) |
| | Creep characteristics | | 0.15 | 0.37 | 0.18 | 0.25 | 0.29 | 0.37 |
| | (shift length mm) | | | | | | | |
| | Elution | 20° C. toluene | 18.9 | 20.8 | 18.9 | 20.2 | 20.0 | 22.9 |
| | percentage | 80° C. toluene | | | | | | |
| | of pressure- | | 25.3 | 34.1 | 25.0 | 32.4 | 31.8 | 37.9 |
| | sensitive | | | | | | | |
| | adhesive (%) | | | | | | | |
| | Plastic | occurrence of whitening | A | A | A | A | A | A |
| | lens PL 1 | occurrence of wrinkles | B | A | B | A | A | A |
| | | occurrence of bubbles | A | A | A | A | A | A |
| | | occurrence of residues | A | A | A | A | A | A |
| | Plastic | occurrence of whitening | A | A | A | A | A | A |
| | lens PL 2 | occurrence of wrinkles | B | A | B | A | A | A |
| | | occurrence of bubbles | A | A | A | A | A | A |
| | | occurrence of residues | A | A | A | A | A | A |

TABLE 3

| | | | | | | Comp. | Comp. | Comp. | Comp. |
|---|---|---|---|---|---|---|---|---|---|
| Item | | | | Example 13 | Example 14 | Example 1 | Example 2 | Example 3 | Example 4 |
| Pressure- | Acrylic | Type | | G | H | I | I | J | K |
| sensitive | copolymer | | | 2-ethyl hexyl | dodecyl | butyl | butyl | 2-ethylhexyl | butyl |
| adhesive | | | | acrylate/ | methacrylate/ | acrylate/ | acrylate/ | acrylate/ | acrylate/ |
| layer | | | | acrylic acid/ | 2- | methyl | methyl | acrylic acid/ | methyl |
| | | | | vinyl acetate | hydroxyethyl | acrylate/2- | acrylate/2- | vinyl acetate | acrylate/2- |
| | | | | copolymer | acrylate/vinyl | hydroxyethyl | hydroxyethyl | copolymer | hydroxyethyl |
| | | | | | acetate | acrylate | acrylate | | acrylate |
| | | | | | copolymer | copolymer | copolymer | | copolymer |
| | | Composition | methyl acrylate | — | — | 10 | 10 | — | 45 |
| | | of | (C number of | | | | | | |
| | | copolymer | alkyl group: 1) | | | | | | |
| | | (% by mass) | butyl acrylate | — | — | 85 | 85 | — | 50 |
| | | | (C number of | | | | | | |
| | | | alkyl group: 4) | | | | | | |
| | | | 2-ethyl hexyl | 83 | — | — | — | 89.5 | — |
| | | | acrylate | | | | | | |
| | | | (C number of | | | | | | |
| | | | alkyl group: 8) | | | | | | |
| | | | isodecyl | — | — | — | — | — | — |
| | | | methacrylate | | | | | | |
| | | | (C number of | | | | | | |
| | | | alkyl group: 10) | | | | | | |
| | | | dodecyl acrylate | — | — | — | — | — | — |
| | | | (C number of | | | | | | |
| | | | alkyl group: 12) | | | | | | |
| | | | dodecyl | — | 83 | — | — | — | — |
| | | | methacrylate | | | | | | |
| | | | (C number of | | | | | | |
| | | | alkyl group: 12) | | | | | | |
| | | | tetradecyl | — | — | | | — | — |
| | | | methacrylate (C | | | | | | |
| | | | number of alkyl | | | | | | |
| | | | group: 14) | | | | | | |
| | | | acrylic acid | 2 | — | — | — | 0.5 | — |
| | | | 2-hydroxyethyl | — | 2 | 5 | 5 | — | 5 |
| | | | acrylate | | | | | | |
| | | | vinyl acetate | 15 | 15 | — | — | 10 | — |
| | | Weight-average molecular | | 1,380,000 | 1,420,000 | 753,000 | 753,000 | 1,020,000 | 672,000 |
| | | weight (M_{w}) | | | | | | | |
| | | Polydispersity (M_{w}/Mₙ) | | 10.0 | 9.8 | 17.1 | 17.1 | 31.2 | 18.2 |
| | | Acid value (mgKOH/g) | | 15.0 | — | — | — | 3.8 | — |
| | | Hydroxyl value (mgKOH/g) | | — | 10.0 | 24.0 | 24.0 | — | 24.0 |
| | | Tg (° C.) | | −57 | −54 | −48 | −48 | −63 | −28 |
| | Blending amount of acrylic copolymer | | | 100 | 100 | 100 | 100 | 100 | 100 |
| | (parts by mass) | | | | | | | | |
| | Blending amount of crosslinking agent | | | 3.7 | 2.3 | 3.0 | 5.0 | 1.5 | 1.5 |
| | (parts by mass) | | | | | | | | |
| | NCO/COOH equivalent ratio | | | 0.59 | — | — | — | 1.07 | — |
| | NCO/OH equivalent ratio | | | — | 0.53 | 0.30 | 0.50 | — | 0.15 |
| Evaluation | Adhesive force on stainless steel (N/10 mm) | | | 4.5 | 3.2 | 4.7 | 4.4 | 5.0 | 5.2 |
| results | Holding force on stainless steel (shift length | | | 0.3 | 0.2 | <0.1 | <0.1 | 1.2 | <0.1 |
| | mm or fallen) | | | (shift length) | (shift length) | (shift length) | (shift length) | (shift length) | (shift length) |
| | Creep characteristics (shift length mm) | | | 0.18 | 0.15 | 0.10 | <0.10 | 0.60 | 0.11 |
| | Elution | 20° C. toluene | | 19.7 | 18.5 | 37.5 | 23.5 | 32.8 | 19.9 |
| | percentage of | 80° C. toluene | | 30.0 | 24.8 | 80.0 | 45.0 | 75.8 | 31.0 |
| | pressure- | | | | | | | | |
| | sensitive | | | | | | | | |
| | adhesive (%) | | | | | | | | |

| | | | | | | | |
|---|---|---|---|---|---|---|---|
| Plastic lens PL | occurrence of whitening | A | A | C | B | C | A |
| 1 | occurrence of wrinkles | B | B | C | C | A | C |
| | occurrence of bubbles | A | A | A | A | A | A |
| | occurrence of residues | A | A | A | A | B | C |
| Plastic lens PL | occurrence of whitening | A | A | C | B | C | A |
| 2 | occurrence of wrinkles | B | B | C | C | A | C |
| | occurrence of bubbles | A | A | A | A | A | A |
| | occurrence of residues | A | A | A | A | B | C |

TABLE 4

| | | | | Comp. | Comp. | Comp. |
|---|---|---|---|---|---|---|
| Item | | | | Example 5 | Example 6 | Example 7 |
| Pressure- | Acrylic | Type | | A-4 | A-1 | A-1 |
| sensitive | copolymer | | | dodecyl | dodecyl | dodecyl |
| adhesive layer | | | | methacrylate/ | methacrylate/ | methacrylate/ |
| | | | | acrylic | acrylic | acrylic |
| | | | | acid/vinyl | acid/vinyl | acid/vinyl |
| | | | | acetate | acetate | acetate |
| | | | | copolymer | copolymer | copolymer |
| | | Composition of | methyl acrylate | — | — | — |
| | | copolymer | (C number of alkyl | | | |
| | | (% by mass) | group: 1) | | | |
| | | | butyl acrylate (C | — | — | — |
| | | | number of alkyl group: | | | |
| | | | 4) | | | |
| | | | 2-ethyl hexyl acrylate | — | — | — |
| | | | (C number of alkyl | | | |
| | | | group: 8) | | | |
| | | | isodecyl methacrylate | — | — | — |
| | | | (C number of alkyl | | | |
| | | | group: 10) | | | |
| | | | dodecyl acrylate (C | — | — | — |
| | | | number of alkyl group: | | | |
| | | | 12) | | | |
| | | | dodecyl methacrylate | 78 | 78 | 78 |
| | | | (C number of alkyl | | | |
| | | | group: 12) | | | |
| | | | tetradecyl | — | — | — |
| | | | methacrylate (C | | | |
| | | | number of alkyl group: | | | |
| | | | 14) | | | |
| | | | acrylic acid | 2 | 2 | 2 |
| | | | 2-hydroxyethyl | — | — | — |
| | | | acrylate | | | |
| | | | vinyl acetate | 20 | 20 | 20 |
| | | Weight-average molecular weight (M_{w}) | | 1,240,000 | 1,320,000 | 1,320,000 |
| | | Polydispersity (M_{w}/Mₙ) | | 16.7 | 9.3 | 9.3 |
| | | Acid value (mgKOH/g) | | 14.8 | 14.8 | 14.8 |
| | | Hydroxyl value (mgKOH/g) | | — | — | — |
| | | Tg (° C.) | | −49 | −49 | −49 |
| | Blending amount of acrylic copolymer (parts by mass) | | | 100 | 100 | 100 |
| | Blending amount of crosslinking agent (parts by mass) | | | 1.4 | 5.3 | 1.2 |
| | NCO/COOH equivalent ratio | | | 0.23 | 0.84 | 0.19 |
| | NCO/OH equivalent ratio | | | — | — | — |
| Evaluation | Adhesive force on stainless steel (N/10 mm) | | | 3.0 | 3.1 | 3.3 |
| results | Holding force on stainless steel (shift length mm or fallen) | | | 1.1 | <0.1 | <1.0 |
| | | | | (shift length) | (shift length) | (shift length) |
| | Creep characteristics (shift length mm) | | | 0.39 | <0.10 | 0.52 |
| | Elution | 20° C. toluene | | 26.8 | 16.5 | 24.9 |
| | percentage of | 80° C. toluene | | 51.6 | 17.0 | 49.5 |
| | pressure- | | | | | |
| | sensitive | | | | | |
| | adhesive (%) | | | | | |

| | | | | |
|---|---|---|---|---|
| Plastic lens PL | occurrence of whitening | C | A | C |
| 1 | occurrence of wrinkles | A | C | A |
| | occurrence of bubbles | A | A | A |
| | occurrence of residues | A | A | B |
| Plastic lens PL | occurrence of whitening | C | A | C |
| 2 | occurrence of wrinkles | A | C | A |
| | occurrence of bubbles | A | A | A |
| | occurrence of residues | A | A | B |

As shown in Tables 1 to 3, in the pressure-sensitive adhesive tapes 1 of Examples 1 to 14 using as the pressure-sensitive adhesive layer 3 the pressure-sensitive adhesive compositions comprising the acrylic copolymer (A1 to A3, B to H) having a functional group having a weight-average molecular weight (M_{w}) in terms of polystyrene of 1,100,000 or more as measured by gel permeation chromatography, and a molecular-weight polydispersity (M_{w}/Mₙ) of 10.0 or less, and a crosslinking agent capable of reacting with the functional group, wherein the elution percentage in toluene the temperature of which being adjusted to 80° C. was made to be 48.0% or less, and the shift length in the creep test was made to be 0.15 mm or more and 0.50 mm or less, it was confirmed that favorable results were obtained in all of the appearance characteristics including whitening in molding of the high refractive index plastic lenses PL1 (refractive index 1.60) and PL2 (refractive index 1.67) by the brief temperature elevation process.

In Example 6 in which, compared with Example 1, Examples 4 to 7, the acid value of the acrylic copolymer was the same, i.e., 14.8 mgKOH/g, but only the content of the crosslinking agent was 1.4% by mass (NCO/COOH=0.23), which was the lowest, since the elution percentage in toluene the temperature of which being adjusted to 80° C. was 47.7%, which was larger than those of other examples, the elution amount of the pressure-sensitive layer 3 in the resin for molding a plastic lens slightly increased. Therefore, slight whitening was observed on the outer peripheral edges of the obtained plastic lenses PL1 and PL2. Further, in Example 7 in which the content of the crosslinking agent was 4.5 mass % by mass (NCO/COOH=0.72), which was the highest, since the shift length in the creep test was less than 0.15 mm, which was smaller than those of the other Examples, the cohesive force of the pressure-sensitive adhesive layer 3 was slightly large, namely the stress relaxation characteristics were slightly inferior. Therefore, slight wrinkles were observed on the side surfaces of the obtained plastic lenses PL1 and PL2.

Further, also in Example 9 in which the acid value of the acrylic copolymer was large, i.e., 37.1 mgKOH/g, and the content of the crosslinking agent was high, i.e., 4.5% by mass, since the shift length in the creep test was 0.15 mm, which was smaller than those of the other Examples, the cohesive force of the pressure-sensitive adhesive layer 3 was slightly large, that is, the stress relaxation characteristics were slightly inferior. Therefore slight wrinkles were observed on the side surfaces of the obtained plastic lenses PL1 and PL2.

Further, in Example 13 in which the carbon number of the alkyl group of the (meth)acrylic acid alkyl ester that was the main component of the acrylic copolymer was 8, and the content of the crosslinking agent was 3.7 parts by mass, since the shift length in the creep test was small, i.e., 0.18 mm, the cohesive force of the pressure-sensitive adhesive layer 3 was slightly larger, that is, the stress relaxation characteristics were slightly inferior compared with Example 5 in which the carbon number of the alkyl group of the (meth)acrylic acid alkyl ester that was the main component of the acrylic copolymer was 12, and the content of the crosslinking agent was 3.7 parts by mass. Therefore, slight wrinkles were observed on the side surfaces of the obtained plastic lenses PL1 and PL2.

Furthermore, in Example 14 in which the functional group of the acrylic copolymer was a hydroxyl group, and the content of the crosslinking agent was 2.3 parts by mass, since the shift length in the creep test was smaller, i.e., 0.15 mm, the cohesive force of the pressure-sensitive adhesive layer 3 was slightly large, that is, the stress relaxation characteristics were slightly inferior compared with Example 4 in which the functional group of the acrylic copolymer was a carboxyl group, and the content of the crosslinking agent was 2.3 parts by mass. Therefore, slight wrinkles were observed on the side surfaces of the obtained plastic lenses PL1 and PL2.

This confirmed that the pressure-sensitive adhesive tapes 1 of Examples 1 to 14 using, as the pressure-sensitive adhesive layer 3, the pressure-sensitive adhesive compositions comprising the acrylic copolymer (A1 to A3, B to H) having a functional group having a weight-average molecular weight (M_{w}) in terms of polystyrene of 1,100,000 or more as measured by gel permeation chromatography, and a molecular-weight polydispersity (M_{w}/Mₙ) of 10.0 or less, and a crosslinking agent capable of reacting with the functional group, wherein the elution percentage in toluene the temperature of which being adjusted to 80° C. was designed to be 48.0% or less, and the shift length in the creep test was designed to be 0.15 mm or more and 0.50 mm or less, were useful as a pressure-sensitive adhesive tape for molding a high refractive index plastic lens by a brief temperature elevation process.

On the other hand, as shown in Tables 3 to 4, in Comparative Examples 1 to 7 in which the pressure-sensitive adhesive layer 3 did not satisfy the constituent requirements of the present invention, it was confirmed that at least any of the evaluation results of whitening, wrinkles, bubbles, and a pressure-sensitive adhesive residue was inferior to those of Examples 1 to 14.

Specifically, in Comparative Example 1 using the acrylic copolymer I having a small weight-average molecular weight (M_{w}), i.e., 753,000 and a large molecular-weight polydispersity (M_{w}/Mₙ), i.e., 17.1, due to the influence of insufficiently-crosslinked low molecular weight components, the elution percentage in toluene the temperature of which being adjusted to 80° C. was extremely high, i.e., 80.0% compared with those of Examples. Therefore, the elution amount of the pressure-sensitive adhesive layer 3 in the resin for molding a plastic lens increased. Therefore, whitening was clearly observed on the outer peripheral edges of the obtained plastic lenses PL1 and PL2. Further, since the shift length in the creep test was also extremely small, i.e., 0.10 mm compared with those of Examples, which was presumably due to the fact that the carbon number of the alkyl group of the (meth)acrylic acid alkyl ester that was the main component was four, and that the functional group of the acrylic copolymer was a hydroxyl group, the cohesive force of the pressure-sensitive adhesive layer 3 was large, that is, the stress relaxation characteristics were inferior. Therefore, wrinkles were clearly observed on the side surfaces of the obtained plastic lenses PL1 and PL2.

Also, in Comparative Example 2 in which the content of the crosslinking agent was increased to 5.0% by mass relative to that of Comparative Example 1, the elution percentage in toluene the temperature of which being adjusted to 80° C. was reduced to 45.0%, and whitening of the outer peripheral edges of the obtained plastic lenses PL1 and PL2 was improved to such an extent that it was slightly observed, however, the shift length in the creep test was also further reduced to 0.10 mm or less. Therefore, the wrinkles on the side surfaces of the obtained plastic lenses PL1 and PL2 were still not improved.

Furthermore, in Comparative Example 3 using the acrylic copolymer J having a small weight-average molecular weight (M_{w}), i.e., 1,020,000, and an extremely large molecular-weight polydispersity (M_{w}/Mₙ), i.e., 31.2, due to the influence of insufficiently-crosslinked low molecular weight components, the elution percentage in toluene the temperature of which being adjusted to 80° C. was extremely large, i.e., 75.8%, compared with those of Examples, and thus the elution amount of the pressure-sensitive adhesive layer 3 in the resin for molding a plastic lens increased. Therefore, whitening was clearly observed on the outer peripheral edges of the obtained plastic lenses PL1 and PL2. Since the shift length in the creep test was 0.60 mm, which was presumably due to the fact that the acrylic copolymer had an acid value of 3.8 mgKOH/g, no wrinkles were observed on the side surfaces of the obtained plastic lenses PL1 and PL2. The pressure-sensitive adhesive residue was at a level in which it was slightly observed on the side surfaces of the molds after the pressure-sensitive adhesive tape 1 has been peeled off.

Furthermore, in Comparative Example 4 using the acrylic copolymer K having a small weight-average molecular weight (M_{w}), i.e., 672,000, a large molecular-weight polydispersity (M_{w}/Mₙ), i.e., 18.2, and containing 45% by mass of methyl acrylate having a carbon number of the alkyl group of the (meth)acrylic acid alkyl ester of one, and 50% by mass of butyl acrylate having a carbon number of the alkyl group of the (meth)acrylic acid alkyl ester of four, the elution percentage in toluene the temperature of which being adjusted to 80° C. was 31.0%, which was particularly presumably due to the fact that the solubility parameter SP value of methyl acrylate was largely detached from the SP value of toluene, and no whitening occurred on the outer peripheral edges of the obtained plastic lenses PL1 and PL2. However, since the shift length in the creep test was also smaller, i.e., 0.11 mm compared with those of Examples, which was presumably due to the fact that the functional group of the acrylic copolymer was a hydroxyl group, and that the carbon number of the alkyl group of the (meth)acrylic alkyl ester was small, wrinkles were clearly observed on the side surfaces of the obtained plastic lenses PL1 and PL2. Furthermore, the pressure-sensitive adhesive residue was clearly observed on the side surfaces of the molds after the pressure-sensitive adhesive tape has been peeled off, which was presumably due to the fact that the weight-average molecular weight (M_{w}) was small, i.e., 672,000.

Furthermore, in Comparative Example 5 using the acrylic copolymer A-4 in which the weight-average molecular weight (Mu) was 1,240,000, which satisfied the range of the present invention, but the molecular-weight polydispersity (M_{w}/Mₙ) was large, i.e., 16.7, which was significantly outside the range of the present invention, the elution percentage in toluene the temperature of which being adjusted to 80° C. was 51.6%, which was smaller than those of Comparative Example 1 and Comparative Example 3. However, compared with Examples, since the value was still large, the elution amount of the pressure-sensitive adhesive layer in the resin for molding a plastic lens increased. Therefore, whitening was clearly observed on the outer peripheral edges of the obtained plastic lenses PL1 and PL2.

Furthermore, in Comparative Example 6 using the acrylic copolymer A-1 in which the weight-average molecular weight (M_{w}) and the molecular-weight polydispersity (M_{w}/Mₙ) satisfied the ranges of the present invention, but the shift length in the creep test was 0.10 mm or less due to the increased adjustment in the content of the crosslinking agent, whitening did not occur on the outer peripheral edges of the obtained plastic lenses PL1 and PL2. However, wrinkles were clearly observed on the side surfaces of the obtained plastic lenses PL1 and PL2.

Furthermore, in Comparative Example 7 using the acrylic copolymer A-1 in which the weight-average molecular weight (M_{w}) and the molecular-weight polydispersity (M_{w}/Mₙ) satisfied the ranges of the present invention, but the elution percentage in toluene the temperature of which being adjusted to 80° C. was 49.5% due to the decreased adjustment in the content of the crosslinking agent, wrinkles did not occur on the side surfaces of the obtained plastic lenses PL1 and PL2, but wrinkles were clearly observed on the outer peripheral edges of the obtained plastic lenses PL1 and PL2. The pressure-sensitive adhesive residue was at a level in which it was slightly observed on the side surfaces of the molds after having peeled off the pressure-sensitive adhesive tape 1.

### DESCRIPTION OF NUMERALS

1 . . . pressure-sensitive adhesive tape, 2 . . . composite substrate, 3 . . . pressure-sensitive adhesive layer, 4 . . . first substrate, 5 . . . inorganic thin film layer, 6 . . . adhesive layer, 7 . . . second substrate, 10 . . . first laminated body, 20 . . . second laminated body, 50 . . . mold, 100 . . . resin for molding a plastic lens

1. A pressure-sensitive adhesive tape for molding a plastic lens having a substrate and a pressure-sensitive adhesive layer formed on a surface of the substrate,
wherein
the pressure-sensitive adhesive layer comprises an acrylic copolymer having a functional group and a crosslinking agent capable of reacting with the functional group; the acrylic copolymer has a weight-average molecular weight (M_{w}) of 1,100,000 or more and a polydispersity molecular weight (M_{w}/Mₙ) of 10.0 or less; the pressure-sensitive adhesive layer has an elution percentage of at 48.0% or less when immersed for two hours in toluene the temperature of which being adjusted to 80° C.; the pressure-sensitive adhesive tape exhibits a shift length of 0.15 mm or more and 0.50 mm or less after 800 minutes in a creep test; and the plastic lens has a refractive index of 1.59 or more.

2. The pressure-sensitive adhesive tape for molding a plastic lens according to claim 1, wherein the acrylic copolymer has a carboxyl group as a functional group, and the crosslinking agent is a polyisocyanate-based compound.

3. The pressure-sensitive adhesive tape for molding a plastic lens according to claim 2, wherein the acrylic copolymer has an acid value of 5.0 to 75.0 mgKOH/g, and the equivalent ratio (NCO/COOH) of the equivalent of the isocyanate group (NCO) of the polyisocyanate-based compound to the equivalent of the carboxyl group (COOH) of the acrylic copolymer is 0.20 to 0.80.

4. The pressure-sensitive adhesive tape for molding a plastic lens according to claim 1, wherein monomers as raw materials of the acrylic copolymer contain a (meth)acrylic acid alkyl ester having an alkyl group having a carbon number of 5 to 18.

5. The pressure-sensitive adhesive tape for molding a plastic lens according to claim 1, wherein the pressure-sensitive adhesive layer has an elution percentage of 38% or less when immersed for 2 hours in toluene the temperature of which being adjusted to 80° C.

6. The pressure-sensitive adhesive tape for molding a plastic lens according to claim 1, wherein the pressure-sensitive adhesive tape has a shift length of 0.20 mm or more and 0.50 mm or less after 800 minutes in a creep test.

7. The pressure-sensitive adhesive tape for molding a plastic lens according to claim 1, wherein the plastic lens is a thiourethane-based resin.

8. The pressure-sensitive adhesive tape for molding a plastic lens according to claim 1, wherein the substrate is a composite substrate in which a sheet-shaped first substrate, an inorganic thin film layer, an adhesive layer, and a sheet-shaped second substrate are sequentially laminated.

9. The pressure-sensitive adhesive tape for molding a plastic lens according to claim 1, which has a water vapor transmission rate according to JIS K 7129 of 1.5 g/(m2/24 h) or less.

10. A method for molding a plastic lens comprising:
a cavity forming step of oppositely arranging a pair of molds at a predetermined interval, sticking the pressure-sensitive adhesive tape for molding a plastic lens according to claim 1 on outer peripheral edges of both the molds, and sealing an opening of a space formed between both the molds to form a cavity into which a polymerizable raw material is filled;
a polymerizable raw material filling step of filling the cavity with a polymerizable raw material for plastic lenses having a refractive index of 1.59 or more; and
a polymerization step of polymerizing the polymerizable raw material.

11. The method for molding a plastic lens according to claim 10, wherein polymerization conditions of the polymerization step include a polymerization start temperature of 45° C. or higher and 65° C. or lower, a final polymerization temperature of 130° C. or higher and 150° C. or lower, and a temperature elevation rate of 0.10° C./min or higher and 0.45° C./min or lower until the final polymerization temperature is reached.

12. The method for molding a plastic lens according to claim 11, wherein the plastic lens is a thiourethane-based resin.

13. The pressure-sensitive adhesive tape for molding a plastic lens according to claim 3, wherein monomers as raw materials of the acrylic copolymer contain a (meth)acrylic acid alkyl ester having an alkyl group having a carbon number of 5 to 18.

14. The pressure-sensitive adhesive tape for molding a plastic lens according to claim 3, wherein the pressure-sensitive adhesive layer has an elution percentage of 38% or less when immersed for 2 hours in toluene the temperature of which being adjusted to 80° C.

15. The pressure-sensitive adhesive tape for molding a plastic lens according to claim 3, wherein the pressure-sensitive adhesive tape has a shift length of 0.20 mm or more and 0.50 mm or less after 800 minutes in a creep test.

16. The pressure-sensitive adhesive tape for molding a plastic lens according to claim 3, wherein the plastic lens is a thiourethane-based resin.

17. The pressure-sensitive adhesive tape for molding a plastic lens according to claim 3, wherein the substrate is a composite substrate in which a sheet-shaped first substrate, an inorganic thin film layer, an adhesive layer, and a sheet-shaped second substrate are sequentially laminated.

18. The pressure-sensitive adhesive tape for molding a plastic lens according to claim 3, which has a water vapor transmission rate according to JIS K 7129 of 1.5 g/(m²/24 h) or less.
